(19) United States
(12) Patent Application Publication
(10) Pub. No.: US 2025/0148609 A1
(43) Pub. Date: May 8, 2025

(54) NOVEL ZERO-CONTACT EDGE DETECTION METHOD FOR ESTIMATION OF REAL-TIME ANGULAR POSITIONS AND ANGULAR VELOCITIES OF A ROTATING STRUCTURE WITH APPLICATION TO ROTATING STRUCTURE VIBRATION MEASUREMENT

(71) Applicant: UNIVERSITY OF MARYLAND, BALTIMORE COUNTY, Baltimore, MD (US)

(72) Inventors: Weidong ZHU, Ellicott City, MD (US); Garrett D. HIGGINS, Baltimore, MD (US); Linfeng LYU, Halethorpe, MD (US)

(21) Appl. No.: 18/727,918

(22) PCT Filed: Jan. 11, 2023
(86) PCT No.: PCT/US2023/060439

§ 371 Date: Jul. 10, 2024

Related U.S. Application Data
(60) Provisional application No. 63/298,376, filed on Jan. 11, 2022.

(51) Int. Cl. G06T 7/12; G01H 9/00; G01P 3/38; G06T 7/136; G06T 7/168; G06T 7/174; G06T 7/246; G06T 7/254

(52) U.S. Cl. CPC G06T 7/12; G01H 9/00; G01P 3/38; G06T 7/136; G06T 7/168; G06T 7/174; G06T 7/246; G06T 7/254; G06T 2207/10016; G06T 2207/30164

(57) ABSTRACT

The present invention relates to zero-contact methods of detecting edges of rotating structures, said methods carried out without attaching an encoder or mark to the rotating structure. The methods were developed for use with image-based tracking continuously scanning laser vibrometer (CSLV) systems for tracking and scanning a rotating structure, using a one-dimensional (1D) or two-dimensional (2D) scan scheme, for vibration measurement and modal parameter identification.

### CROSS REFERENCE TO RELATED APPLICATIONS

This application claims priority to U.S. Provisional Patent Application No. 63/298,376 filed on Jan. 11, 2022 in the name of Weidong ZHU et al. and U.S. Provisional Patent Application No. 63/309,121 filed on Feb. 11, 2022 in the name of Weidong ZHU et al., both entitled “NOVEL ZERO-CONTACT EDGE DETECTION METHOD FOR ESTIMATION OF REAL-TIME ANGULAR POSITIONS AND ANGULAR VELOCITIES OF A ROTATING STRUCTURE WITH APPLICATION TO ROTATING STRUCTURE VIBRATION MEASUREMENT,” both of which are hereby incorporated by reference herein in their entirety.

### STATEMENT OF FEDERALLY SPONSORED RESEARCH

This invention was made with government support under Grant No. CMMI-1763024 awarded by the National Science Foundation. The government has certain rights in the invention.

### FIELD

The present invention relates to zero-contact methods of detecting edges of rotating structures, said methods carried out without attaching an encoder or mark to the rotating structure. The methods were developed for use with image-based tracking continuously scanning laser vibrometer (CSLV) systems for tracking and scanning a rotating structure, using a one-dimensional (1D) or two-dimensional (2D) scan scheme, for vibration measurement and modal parameter identification.

### BACKGROUND

Global wind power capacity has continued to grow rapidly over the past few decades. In 2020, the newly installed capacity of global wind power reached a record of nearly 93 GW, and the cumulative installed capacity of global wind power was 743 GW. Horizontal-axis wind turbines produce most of wind power in the world today. Most installed wind turbines are aging, which is driving the growth of the operation and maintenance (O&M) market of wind power and the need for advanced repair techniques of wind turbines. Blades are the fifth largest contributors of overall wind turbine failure, accounting for 6.2% of overall wind turbine failure and as such, wind turbine blades should be monitored under operational conditions to detect potential damages that may cause sudden failures of wind turbines. Currently, visual inspection is the primary means of vibration monitoring and structural health monitoring (SHM) for stationary wind turbine blades, which can take 1-3 days, is dangerous, and can cost upwards of 10,000€ for one wind turbine per year. Accordingly, an efficient and low-cost non-contact method is urgently needed for monitoring vibrations of wind turbine blades under operational conditions.

Contactless vibration monitoring and SHM of a rotating structure such as a rotating wind turbine blade includes the determination of its position at any time instant. Image-based methods, such as edge detection methods, are suitable for determining the position of a moving object without attaching any sensor to said object. An edge detection method converts a digital image to a binary image by locating discontinuities of image brightness, and these discontinuities may correspond to edges of the object in the image [1]. An edge detection method basically consists of filtering, enhancement, detection, and localization [2]. Filtering is removing ambient noise in an image while keeping all strong edges clear in the image. Enhancement is emphasizing regions where pixel intensity varies significantly to aid gradient computation. Detection is removing false edges due to noise while preserving pixels that make up true edges in the image. Localization is obtaining exact locations of edges in the image [2-4]. Edge detection methods have been used for motion tracking; however, these methods were developed only for determining positions of a moving structure, and have not been applied to vibration monitoring and SHM of a rotating structure.

To measure vibration of a rotation structure without contact, one can combine an edge detection method and noncontact vibration measurement method. A laser Doppler vibrometer is a suitable noncontact method for vibration monitoring and SHM of a structure since it accurately measures the structural surface velocity of a point [5,6]. Continuously scanning laser Doppler vibrometer (CSLDV) systems that can sweep a laser spot on a prescribed scan path have been developed to measure vibration on the scan path, both for processing measurements obtained on straight scan paths to estimate 1D modal parameters as well as using a 2D scan scheme that can let a CSLDV system scan its whole surface. Some prior art laser vibrometer systems track moving objects and detect edges by attaching marks to the rotating structures and processing their images to determine real-time positions of marks, but these systems are difficult to use to track large rotating wind turbine blades since it is difficult to attach marks to wind turbine blades. An edge detection method was developed for an image-based tracking continuously scanning laser Doppler (CSLD) system to track a rotating structure without attaching any encoder or mark to it [7], but this edge detection method works when images of the rotating structure have a simple background. Moreover, mounting any kind of feature to a structure through physical interaction makes reliable measurements susceptible to human negligence and influence, which can potentially skew measurements and increase error in the results. Attaching a mark or pattern to the surface of a structure and preparing the structure's surface entails slowing or completely stopping the system to do so. Systems that are analyzed in controlled environments can be easily slowed or stopped but it can be a complicated process to slow or stop a large-scale system, such as a turbine blade of an offshore wind turbine.

The present invention represents an improvement in the art, including zero-contact methods of detecting edges of rotating structures, said methods carried out without attaching an encoder or mark to the rotating structure. The methods were developed for use with image-based tracking continuously scanning laser vibrometer (CSLV) systems for tracking and scanning a rotating structure, using a 1D or 2D scan scheme, for vibration measurement and modal parameter identification.

### SUMMARY

In some aspects, a method of detecting and identifying edges of a rotating structure (RS) for an image-based tracking system is described, the method comprising:
determining real-time positions of points on edges of the RS by processing images captured by the image-based tracking system; and
using the image-based tracking system to scan at least a portion of a surface of the RS using a one-dimensional (1D) or two-dimensional (2D) scan scheme,
wherein the method is performed without attaching any mark or encoder to the RS.

In some embodiments, the 1D scan scheme comprises generating straight scan paths on the RS based on positions of edge points detected. In some embodiments, the 2D scan scheme sweeps a laser spot along a zigzag scan path on at least a portion of a surface of the RS to measure vibration of the RS.

In some embodiments, the image-based tracking system is a tracking continuously scanning laser vibrometer (CSLV) system. In some embodiments, the tracking CSLV system is a tracking continuously scanning laser Doppler vibrometer (CSLDV system. In some embodiments, the system includes a camera, a scanner, and a single-point laser vibrometer. In some embodiments, the system includes a single-point laser vibrometer, a scanner with a set of orthogonal mirrors, and a camera to sweep a laser spot along generated scan paths. In some embodiments, the tracking CSLV system measures velocities, displacements, or accelerations of points on generated scan paths.

In some embodiments, the RS is a wind turbine blade.

In some embodiments, the method further comprises extracting edges of the RS from a complex background by processing images of the RS. In some embodiments, the edges are extracted using two video frames to form a differential frame by subtracting a first frame from a second frame, wherein the first frame and the second frame are consecutive, and wherein all stationary objects in the frame are removed.

In some embodiments, the method further comprises obtaining at least one modal parameter using a modal analysis method. In some embodiments, the modal parameters include damped natural frequencies and full-field undamped mode shapes. In some embodiments, the modal analysis method comprises an improved demodulation method comprising processing measured data of response of the RS under random excitation and estimating its modal parameters with different constant speeds. In some embodiments, the modal analysis method comprises an improved lifting method

In some embodiments, the position of an edge of the RS is determined using distance conditions. In some embodiments, the distance conditions include (a) a point for edge detection that is the center of a circular edge detection region, (b) an image sub-frame, and (iii) values of radial bounds.

In some embodiments, the method is a zero-contact method.

In another aspect, a method of estimating a rotation speed of a blade of a rotating structure is described, said method comprising the method of detecting and identifying edges of a rotating structure (RS) for an image-based tracking system, wherein said method comprises:
determining real-time positions of points on edges of the RS by processing images captured by the image-based tracking system; and
using the image-based tracking system to scan at least a portion of a surface of the RS using a one-dimensional (1D) or two-dimensional (2D) scan scheme,
wherein the method is performed without attaching any mark or encoder to the RS.

In still another aspect, a method for estimating angular positions and/or angular velocities of a rotating structure (RS) using edge detection is described, the method comprising:
detecting edges of the RS by tracking a location of an identified point;
transforming the location of the identified point into polar coordinates to determine angular positions; and
using the angular positions to calculate real-time angular velocities,
wherein the method is performed without attaching any mark or encoder to the RS.

In some embodiments, the method is a zero-contact method.

In some embodiments, the method utilizes a monocular camera system.

In some embodiments, the location of the identified point is determined by:
reducing the size of an image processing region to generate a sub-frame;
detecting a rotation center of the RS;
generating an annular region around the rotation center; and
using a virtual reference point to detect a plurality of single identified points on the edge of the RS within the annular region, wherein when the edges enter the region around the virtual reference position, the average location of the edges is calculated. In some embodiments, the detection of the rotation center comprises constructing a cumulative differential frame from a sequence of consecutive frames.

In some embodiments, the identified point is a single identified point.

In some embodiments, the identified point is an average of the plurality of single identified points.

In some embodiments, the RS is a wind turbine blade.

In some embodiments, the image processing region includes the RS.

In some embodiments, wherein the method comprises at least one of the following conditions: (a) the rotation center and a region around it are static and stable; (b) the rotation center is visible to a camera with substantially no occlusions; (c) a center hub of the RS and portions of the blades close to the center hub have a substantially homogeneous color, a substantially smooth profile, and a substantially continuous geometry; and (d) the blades of the RS are one of the largest moving objects or the only moving objects in the image processing region.

In yet another aspect, a method of detecting and identifying edges of a rotating structure (RS) is described, the method comprising:
reducing the size of an image processing region to generate a sub-frame;
detecting a rotation center of the RS;
generating an annular region around the rotation center; and
using a virtual reference point to detect a plurality of single identified points on the edge of the RS within the annular region, wherein when the edges enter the region around the virtual reference position, the average location of the edges is calculated.

In some embodiments, the detection of the rotation center comprises constructing a cumulative differential frame from a sequence of consecutive frames.

In some embodiments, the identified point is a single identified point.

In some embodiments, the identified point is an average of the plurality of single identified points.

In some embodiments, the RS is a wind turbine blade.

In some embodiments, the image processing region includes the RS.

In some embodiments, the method further comprises at least one of the following conditions: (a) the rotation center and a region around it are static and stable; (b) the rotation center is visible to a camera with substantially no occlusions; (c) a center hub of the RS and portions of the blades close to the center hub have a substantially homogeneous color, a substantially smooth profile, and a substantially continuous geometry; and (d) the blades of the RS are one of the largest moving objects or the only moving objects in the image processing region.

Other aspects, features and embodiments of the invention will be more fully apparent from the ensuing disclosure and appended claims.

### BRIEF DESCRIPTION OF THE FIGURES

FIG. 1A. An image of the fan with a complex background.

FIG. 1B. An edge map of the fan with the complex background.

FIG. 2A. An illustration of the relative position of a single blade between two consecutive frames.

FIG. 2B. The three regions of consideration within the sub-frame made by the blade's positions between frames.

FIG. 3. A differential frame made by two consecutive frames by subtracting the previous frame from the current frame.

FIG. 4A. An illustration of using transformation constants to construct sub-frame dimensions around the rotation center.

FIG. 4B. An illustration of radial bounds defined within the extracted sub-frame.

FIG. 5A. An edge map from applying Sobel edge detection to the differential frame in FIG. 3 with the fan blade's non-uniform geometry indicated by the circle.

FIG. 5B. Radial bounds defined to exclude the non-uniform geometry portion of the fan blades.

FIG. 6A. An example of the scan path generated on the rotating blade.

FIG. 6B. The shifted edge point on the rotating blade.

FIG. 7A. The components in the image-based tracking CSLDV system in an example of one embodiments described herein.

FIG. 7B. The experimental setup of tracking and scanning a rotating fan blade with a complex background.

FIG. 7C. A rotary encoder that was attached to the fan hub for rotation speed measurement for validation purposes.

FIG. 8A. Images of the rotating fan captured by the camera in the image-based tracking CSLDV system with the black tarp covering the wall.

FIG. 8B. Images of the rotating fan captured by the camera in the image-based tracking CSLDV system with the black tarp not covering the wall.

FIG. 8C. Differential frames obtained from images captured by the camera with the black tarp covering the wall.

FIG. 8D. Differential frames obtained from images captured by the camera with the black tarp not covering the wall.

FIG. 8E. The edge map from applying Sobel edge detection to FIG. 8C.

FIG. 8F. The edge map from applying Sobel edge detection to FIG. 8D.

FIG. 9A. Estimated edge positions of a rotating fan blade with low speeds.

FIG. 9B. Estimated edge positions of a rotating fan blade with medium speeds.

FIG. 9C. Estimated edge positions of a rotating fan blade with high speeds.

FIG. 10A. Measured responses of the image-based tracking CSLDV system when the fan was stationary.

FIG. 10B. Measured responses of the image-based tracking CSLDV system when the fan had a constant speed of R=18.95 rpm.

FIG. 10C. Measured responses of the image-based tracking CSLDV system when the fan had a constant speed of R=24.30 rpm.

FIG. 10D. The estimated rotation speeds of the fan.

FIG. 11A. A schematic of the rotating fan.

FIG. 11B. A schematic of the square region of the fan of FIG. 11A for edge detection.

FIG. 12A. A schematic of edge points that satisfy the distance condition.

FIG. 12B. Simulated ideal edge point positions and edge point positions that are measured by the tracking CSLDV system with the jitter effect.

FIG. 12C. Simulated edge point positions on a smooth circle reconstructed from simulated edge point positions that are measured by the tracking CSLDV system with the jitter effect in FIG. 12B.

FIG. 13. Schematic for determining end points of the scan path based on the reconstructed edge point.

FIG. 14A. Simulated mirror signal for scanning a stationary structure.

FIG. 14B. Simulated X- and Y-mirror signals and the processed mirror signal.

FIG. 14C. The simulated trajectory of the laser spot in the O-XY coordinate system.

FIG. 15. A schematic of a non-uniform rotating beam.

FIG. 16A. A picture of the experimental setup of tracking and scanning the rotating fan blade.

FIG. 16B. A picture of the tracking CSLDV system.

FIG. 16C. A schematic of tracking and scanning the rotating fan blade.

FIG. 17A. An image of a rotating fan captured by the camera.

FIG. 17B. A processed image that shows the identified edges of the rotating fan of FIG. 17A.

FIG. 18. An image of the square region for determining the position of an edge point to track.

FIG. 19A. X- and Y-mirror signals of the tracking CSLDV system when R=27.72 rpm.

FIG. 19B. The processed mirror signals from mirror signals in FIG. 19A.

FIG. 19C. The angle of the laser spot obtained from FIG. 19A in the polar coordinate system whose pole is the hub center and polar axis is along the X direction.

FIG. 19D. The processed angle from FIG. 19C.

FIG. 19E. The estimated constant and non-constant rotation speeds of the fan blade.

FIG. 20A. Measured response of the tracking CSLDV system when R=27.72 rpm.

FIG. 20B. The fast Fourier transform (FFT) of the measured response in FIG. 20A.

FIG. 20C. The filtered measured response and corresponding processed mirror signal.

FIG. 20D. The first mode shape estimated from the filtered measured response in FIG. 20C.

FIG. 21A. Original 720×720 frame showing the experimental setup with the rotation center marked.

FIG. 21B. A 350×350 sub-frame for processing.

FIG. 21C. The difference in processing times when both frames are subjected to Sobel edge detection.

FIG. 22A. Differential frames showing the angular displacement of the leading edge.

FIG. 22B. Differential frames showing the angular displacement of the trailing edge.

FIG. 22C. The combined angular displacement of both edges shown in FIGS. 22A and 22B.

FIG. 23A. Cumulative differential frames formed by the sum of 5 consecutive frames.

FIG. 23B. Cumulative differential frames formed by the sum of 10 consecutive frames.

FIG. 23C. Cumulative differential frames formed by the sum of 15 consecutive frames.

FIG. 24. Rotation center is marked and used to construct two larger radii around it.

FIG. 25A. Edges located outside the inner radial bound.

FIG. 25B. Edges located within the outer radial bound.

FIG. 25C. Edges that reside between the radii.

FIG. 26A. Illustration of the reference position before edges are near it.

FIG. 26B. Illustration of the reference position when it detects the first edge.

FIG. 26C. Illustration of the reference position when it detects the second edge.

FIG. 26D. The average position of the edges forces the reference position to be in the middle of the blade as it rotates.

FIG. 26E. The average position of the edges forces the reference position to be in the middle of the blade as it continues to rotate.

FIG. 26F. The average position of the edges forces the reference position to be in the middle of the blade as it continues to rotate.

FIG. 27. Picture of the rotary encoder assembly.

FIG. 28A. The cumulative differential frame of a turbine of interest from one video overlayed with a rectangle that illustrates the sub-frame relative to the initial frame.

FIG. 28B. The sub-frame of FIG. 28A with test points indicated.

FIG. 29. Angular velocities in rotations per minute of the fan obtained from the edge detection method.

FIG. 30. Angular velocities obtained from the rotary encoder along with the Gaussian-filtered angular velocities.

FIG. 31. Comparison of the angular velocities from the edge detection and encoder methods.

FIG. 32. Frame processing times for each video with the frame rate of the videos indicated by the horizontal line.

FIG. 33. Angular velocity calculations for a video with non-uniform and uniform processing times, and the results of Gaussian weighted moving-average filtering.

### DETAILED DESCRIPTION, AND PREFERRED EMBODIMENTS THEREOF

Although the claimed subject matter will be described in terms of certain embodiments, other embodiments, including embodiments that do not provide all of the benefits and features set forth herein, are within the scope of this disclosure as well. Various structural and parameter changes may be made without departing from the scope of this disclosure.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents, and other references mentioned herein are incorporated by reference in their entirety. The materials, methods, and examples disclosed herein are illustrative only and not intended to be limiting.

“About” and “approximately” are used to provide flexibility to a numerical range endpoint by providing that a given value may be “slightly above” or “slightly below” the endpoint without affecting the desired result, for example, +/−5%.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the “image-based tracking system” can include, but is not limited to, a tracking CSLV system or a tracking CSLDV system, wherein a CSLDV system is a species of the CSLV system genus.

As defined herein, “zero-contact” or “non-contact” corresponds to no physical interaction with the RS, e.g., the blades or the hub of the RS, and the maintenance of zero physical contact with the RS, e.g., the blades or the hub of the RS, before, during, and after measurements are performed.

As defined herein, a “rotating structure” includes structures with rotating blades including, but not limited to, a horizontal-axis wind turbine or a helicopter.

Broadly, in a first aspect, the present invention relates to an edge detection method for an image-based tracking CSLV system, for example as described in references [7-10], for tracking and scanning a rotating structure. In some embodiments, the tracking CSLV system is a CSLDV system. Advantageously, the image-based tracking CSLV system can track and scan a rotating structure, e.g., an actual rotating wind turbine blade, without attaching an encoder or mark to the rotating structure. In some embodiments, a 2D scan scheme is used to sweep the laser spot along the whole surface of the rotating structure. In some embodiments, a 1D scan scheme is used to scan straight paths on the rotating structure based on positions of edge points detected. In some embodiments, the edge detection method further comprises the extraction of edges of the rotating structure from its complex background by processing images of the rotating structure. Once edges of the rotating structure are clearly shown in the processed image, their positions can be easily determined. Modal parameters of the rotating fan blade are estimated using a modal analysis method, for example, the improved demodulation method, as described in Refs. [7, 9, 10], or an improved lifting method [8], which both deal with a structure under random excitation instead of sinusoidal excitation for the demodulation method or impact excitation for the lifting method. Using the improved demodulation method, damped natural frequencies and undamped mode shapes of the rotating fan blade with different constant speeds and its instantaneous undamped mode shapes with a non-constant speed are estimated by processing data measured by the tracking CSLV system. The image-based tracking CSLV system described in this example can be used to track and scan actual wind turbine blades and monitor their vibrations and velocity.

In an embodiment of the first aspect, a method of detecting and identifying edges of a rotating structure (RS) for an image-based tracking system is described, the method comprising:
determining real-time positions of points on edges of the RS by processing images captured by the image-based tracking system; and
using the image-based tracking system to scan at least a portion of a surface of the RS using a 1D or 2D scan scheme,
wherein the method is performed without attaching any mark or encoder to the RS.

In another embodiment of the first aspect, a method of detecting and identifying edges of an RS for a tracking CSLV system is described, the method comprising:
determining real-time positions of points on edges of the RS by processing images captured by the tracking CSLV system; and
using the tracking CSLV system to scan at least a portion of a surface of the RS using a 1D or 2D scan scheme,
wherein the method is performed without attaching any mark or encoder to the RS.

In still another embodiment of the first aspect, a method of detecting and identifying edges of a rotating structure (RS) for an image-based tracking system is described, the method comprising:
determining real-time positions of points on edges of the RS by processing images captured by the image-based tracking system; and
using the image-based tracking system to scan at least a portion of a surface of the RS using a 1D or 2D scan scheme,
wherein the method is performed without attaching any mark or encoder to the RS, and wherein the method further comprises extracting edges of the rotating structure from a complex background by processing images of the rotating structure.

In yet another embodiment of the first aspect, a method of detecting and identifying edges of a rotating structure (RS) for an image-based tracking system is described, the method comprising:
determining real-time positions of points on edges of the RS by processing images captured by the image-based tracking system; and
using the image-based tracking system to scan at least a portion of a surface of the RS using a 1D or 2D scan scheme,
wherein the method is performed without attaching any mark or encoder to the RS, and wherein the method further comprises extracting edges of the rotating structure from a complex background by processing images of the rotating structure.

With regards to the methods of the first aspect, in some embodiments, the 1D scan scheme can comprise generating straight scan paths on the RS based on positions of edge points detected. With regards to the methods of the first aspect, in some embodiments, the 2D scan scheme sweeps a laser spot along a zigzag scan path on at least a portion of a surface of the RS to measure vibration of the RS. With regards to the methods of the first aspect, in some embodiments, the image-based tracking system is a tracking CSLV system. With regards to the methods of the first aspect, in some embodiments, the tracking CSLV system is a tracking CSLDV system. With regards to the methods of the first aspect, in some embodiments, the system includes a camera, a scanner, and a single-point laser vibrometer. With regards to the methods of the first aspect, in some embodiments, the system includes a single-point laser vibrometer, a scanner with a set of orthogonal mirrors, and a camera to sweep a laser spot along generated scan paths. With regards to the methods of the first aspect, in some embodiments, the tracking CSLV system measures velocities, displacements, or accelerations of points on generated scan paths. With regards to the methods of the first aspect, in some embodiments, the RS comprises a blade. In some embodiments, the RS comprises a wind turbine blade. With regards to the methods of the first aspect, in some embodiments, the method of the first aspect further comprises extracting edges of the RS from a complex background by processing images of the RS. With regards to the methods of the first aspect, in some embodiments, the edges are extracted using two video frames to form a differential frame by subtracting a first frame from a second frame, wherein the first frame and the second frame are consecutive, and wherein all stationary objects in the frame are removed. With regards to the methods of the first aspect, in some embodiments, the method further comprises processing using a modal analysis method selected from an improved demodulation method or an improved lifting method. With regards to the methods of the first aspect, in some embodiments, the method further comprises processing using an improved demodulation method, which comprises processing measured data of response of the RS under random excitation and estimating its modal parameters with different constant speeds. With regards to the methods of the first aspect, in some embodiments, the modal parameters include damped natural frequencies and full-field undamped mode shapes. With regards to the methods of the first aspect, in some embodiments, the method further comprises processing using an improved lifting method. With regards to the methods of the first aspect, in some embodiments, the position of an edge of the RS is determined using distance conditions. With regards to the methods of the first aspect, in some embodiments, the distance conditions include (a) a point for edge detection that is the center of a circular edge detection region, (b) an image sub-frame, and (iii) values of radial bounds. With regards to the methods of the first aspect, in some embodiments, the method is a zero-contact method.

Broadly, in a second aspect, a method for estimating angular positions and/or angular velocities of a rotating structure (RS) using edge detection is described, the method comprising:
detecting edges of the RS by tracking a location of an identified point;
transforming the location of the identified point into polar coordinates to determine angular positions; and
using the angular positions to calculate real-time angular velocities,
wherein the method is performed without attaching any mark or encoder to the RS.

With regards to the method of the second aspect, in some embodiments, the method is a zero-contact method. With regards to the method of the second aspect, in some embodiments, the method utilizes a monocular camera system. With regards to the method of the second aspect, in some embodiments, the location of the identified point is determined by: reducing the size of an image processing region to generate a sub-frame; detecting a rotation center of the RS; generating an annular region around the rotation center; and using a virtual reference point to detect a plurality of single identified points on the edge of the RS within the annular region, wherein when the edges enter the region around the virtual reference position, the average location of the edges is calculated. With regards to the method of the second aspect, in some embodiments, the detection of the rotation center comprises constructing a cumulative differential frame from a sequence of consecutive frames. With regards to the method of the second aspect, in some embodiments, the identified point is a single identified point. With regards to the method of the second aspect, in some embodiments, the identified point is an average of the plurality of single identified points. With regards to the method of the second aspect, in some embodiments, the RS is a wind turbine blade. With regards to the method of the second aspect, in some embodiments, the image processing region includes the RS. With regards to the method of the second aspect, in some embodiments,
the method comprises at least one of the following conditions: (a) the rotation center and a region around it are static and stable; (b) the rotation center is visible to a camera with substantially no occlusions; (c) a center hub of the RS and portions of the blades close to the center hub have a substantially homogeneous color, a substantially smooth profile, and a substantially continuous geometry; and (d) the blades of the RS are one of the largest moving objects or the only moving objects in the image processing region.

In a third aspect, a method of estimating a rotation speed of a blade of a rotating structure is described, said method comprising the method of detecting and identifying edges of a RS for an image-based tracking system of the first aspect.

In a fourth aspect, a method of detecting rotating structure damage is described, said method comprising the method of detecting and identifying edges of a RS for an image-based tracking system of the first aspect.

In a fifth aspect, a method of detecting and identifying edges of a rotating structure (RS) is described, the method comprising:
reducing the size of an image processing region to generate a sub-frame;
detecting a rotation center of the RS;
generating an annular region around the rotation center; and
using a virtual reference point to detect a plurality of single identified points on the edge of the RS within the annular region, wherein when the edges enter the region around the virtual reference position, the average location of the edges is calculated.

With regards to the method of the fifth aspect, in some embodiments, the detection of the rotation center comprises constructing a cumulative differential frame from a sequence of consecutive frames. With regards to the method of the fifth aspect, in some embodiments, the identified point is a single identified point. With regards to the method of the fifth aspect, in some embodiments, the identified point is an average of the plurality of single identified points. With regards to the method of the fifth aspect, in some embodiments, the RS is a wind turbine blade. With regards to the method of the fifth aspect, in some embodiments, the image processing region includes the RS. With regards to the method of the fifth aspect, in some embodiments, wherein the method comprises at least one of the following conditions: (a) the rotation center and a region around it are static and stable; (b) the rotation center is visible to a camera with substantially no occlusions; (c) a center hub of the RS and portions of the blades close to the center hub have a substantially homogeneous color, a substantially smooth profile, and a substantially continuous geometry; and (d) the blades of the RS are one of the largest moving objects or the only moving objects in the image processing region.

The features and advantages of the invention are more fully illustrated by the following non-limiting examples, wherein all parts and percentages are by weight, unless otherwise expressly stated.

### Modal Analysis Methods

A modal analysis method, herein referred to as the “improved demodulation method,” was previously described in co-pending U.S. patent application Ser. No. 18/048,567, filed on Oct. 21, 2022 in the name of Weidong ZHU and Linfeng LYU, which is hereby incorporated by reference in its entirety herein. Briefly, the improved demodulation method uses a 2D scan scheme to estimate higher full-field mode shapes of a rotating structure subject to random excitation. The improved demodulation method is based on a rigorous nonuniform rotating beam vibration theory and uses image processing to estimate modal parameters of the structure, including damped natural frequencies and end-to-end undamped mode shapes, under random excitation to estimate the rotation speed and modal parameters of a rotating structure. A camera is used to capture images of the rotating structure and is integrated into a CSLDV system to track the rotating structure by processing its images. Damped natural frequencies of the rotating structure are obtained from an FFT of its response measured by the CSLDV system. End-to-end undamped mode shapes of the rotating structure can be obtained by multiplying the measured response by sinusoidal signals with its damped natural frequencies and applying a low-pass filter to the multiplied measured response. The method can estimate damped natural frequencies and end-to-end undamped mode shapes of the rotating structure with a constant speed and their instantaneous values in a short time duration for a non-constant rotation speed. The estimated end-to-end undamped mode shapes of the rotating structure under random excitation can be used to detect damage, e.g., wind turbine blade damage. Advantageously, the improved demodulation method can estimate higher modes of an RS using a low frame-rate camera and a low scan frequency, while the lifting method cannot.

A non-uniform rotating Euler-Bernoulli beam model is used to describe the rotating fan blade (FIG. 15). The rotating beam has a length of l, and the radius of the hub is r. The inertial coordinate system O-XYZ and a rotating coordinate system o-xyz are used to describe rigid body motion and vibration of the rotating beam, respectively. The origin O and X and Y axes in the O-XYZ coordinate system are the same as those in FIG. 11A. The origin o of the o-xyz coordinate system is located at the rotation center of the beam, and the x-axis is along the length direction of the rotating beam. The equation of motion and associated boundary conditions of the rotating beam under excitation of a distributed random force f(x,t) along the z direction can be derived as [9]

$$ρ ( x ) \ddot{z} ( x , t ) + C [ \dot{z} ( x , t ) ] + {[ EI ( x ) {z}_{x x} ( x , t ) ]}_{x x} - {z}_{x x} ( x , t ) \dot{θ} ( t ) {\int }_{x}^{r + l} ρ ( p ) p d p + ρ ( x ) x {z}_{x} ( x , t ) {\dot{θ}}^{2} ( t ) = f ( x , t ) , r \leq x \leq r + l , t > 0 \qquad ( 1 )$$

$${{{{z ( x , t ) \vert}_{x = r} = 0 , {z}_{x} ( x , t ) \vert}_{x = r} = 0 , {z}_{x x} ( x , t ) \vert}_{x = r + l} = 0 , \\ {[ EI ( x ) {z}_{x x} ( x , t ) ]}_{x} \vert}_{x = r + l} = 0 \qquad ( 2 )$$

where x is the spatial position along the x direction, p (x) is the mass per unit length of the rotating beam at the position x, z(x,t) is the displacement of the rotating beam at x and time t, a subscript and an overdot denote partial differentiation with respect to x and t, respectively, C is the spatial damping operator, and EI(x) is the flexural rigidity of the beam at x. The term −zₓₓ(x,t)\dot{θ}(t)∫ₓ^{r+l}ρ(p)pdp+ρ(x)xzₓ(x,t)\dot{θ}²(t) in Eq. (1) is related to the centrifugal stiffening effect caused by rotation. Let \dot{θ}(t)=Ω be a constant that means that the beam rotates with a constant speed; the solution to the equation of motion of the rotating beam under excitation of a concentrated random force applied at the position xₐ can be derived as [9]

$$z ( x , t ) = {\sum }_{i = 1}^{∞} {ϕ}_{i} ( x ) {ϕ}_{i} ( {x}_{a} ) {\int }_{0}^{t} {f}_{a} ( t - τ ) ( 1 / {ω}_{d , i} ) {e}^{- {ζ}_{i} {ω}_{i} τ} sin ( {ω}_{d , i} τ ) d τ \qquad ( 3 )$$

where ϕᵢ(x) is the i-th undamped mode shape of the rotating beam, fₐ is the concentrated random force, and ωᵢ and ω_{d,i} are the i-th undamped and damped natural frequency of the rotating beam, respectively, and ζᵢ is its i-th modal damping ratio. Measurement of the tracking CSLDV system when scanning a rotating structure can be expressed by Eq. (3), and the improved demodulation method in Ref. [9] (and as discussed herein) can be applied to the measurement to estimate undamped mode shapes of the rotating beam. As introduced in Ref. [9], equation (3) can be written as

$$z ( x , t ) = {\sum }_{i = 1}^{∞} {ϕ}_{i} ( x ) {ϕ}_{i} ( {x}_{a} ) \{ {A}_{i} ( t ) sin ( {ω}_{d , i} t ) + {B}_{i} ( t ) cos ( {ω}_{d , i} t ) + {C}_{i} ( t ) \} \qquad ( 4 )$$

where Aᵢ(t), Bᵢ(t), and Cᵢ(t) are functions related to fₐ (t). A low-pass filter whose passband only contains ω_{d,i} is applied to Eq. (4), to obtain

$${z}_{i} ( x , t ) = {Φ}_{Q , i} ( x ) sin ( {ω}_{d , i} t ) + {Φ}_{I , i} ( x ) cos ( {ω}_{d , i} t ) = {H}_{i} {ϕ}_{i} ( x ) sin ( {ω}_{d , i} t + γ ) \qquad ( 5 )$$

where zᵢ(x,t) is the signal obtained after z(x,t) is filtered, Hᵢ is a scalar factor, γ is a phase variable, and Φ_{Q,i}(x) and Φ_{I,i}(x) are quadrature and in-plane components of Hᵢϕᵢ(x), respectively. Equation (5) is multiplied by sin (ω_{d,i}t) and cos (ω_{d,i}t) to obtain Φ_{Q,i}(x) and Φ_{I,i}(x), respectively:

$${Φ}_{Q , i} ( x ) ( {ω}_{d , i} t ) {sin}^{2} ( {ω}_{d , i} t ) + {Φ}_{I , i} ( x ) sin ( {ω}_{d , i} t ) cos ( {ω}_{d , i} t ) = \frac{1}{2} {Φ}_{Q , i} ( x ) + \frac{1}{2} {Φ}_{I , i} ( x ) sin ( 2 {ω}_{d , i} t ) - \frac{1}{2} {Φ}_{Q , i} ( x ) cos ( 2 {ω}_{d , i} t ) \qquad ( 6 )$$

$${Φ}_{Q , i} ( x ) sin ( {ω}_{d , i} t ) cos ( {ω}_{d , i} t ) + {Φ}_{I , i} ( x ) ( {ω}_{d , i} t ) {cos}^{2} ( {ω}_{d , i} t ) = \frac{1}{2} {Φ}_{I , i} ( x ) + \frac{1}{2} {Φ}_{I , i} ( x ) cos ( 2 {ω}_{d , i} t ) + \frac{1}{2} {Φ}_{Q , i} ( x ) sin ( 2 {ω}_{d , i} t ) \qquad ( 7 )$$

Undamped mode shapes of the rotating beam can be obtained using Eqs. (5), (6), and (7) [9]. Note that this improved demodulation method can estimate undamped mode shapes of a structure under random excitation.

One embodiment of the improved demodulation method comprises: measuring a response of a rotating structure subject to random excitation with a system; determining an FFT of the response; applying a bandpass filter to the response with a passband that includes a damped natural frequency of the rotating structure to create a filtered response; determining a time interval between a minimum value and a maximum value of the filtered response; multiplying the filtered response in the time interval by sinusoidal signals to create a plurality of processed responses; and applying a lowpass filter to the plurality of processed responses to obtain an end-to-end undamped mode shape of the rotating structure (e.g., in-plane and quadrature components of an end-to-end undamped mode shape). In some embodiments, the sinusoidal signals include cos(ω_{d,i}t) and sin(ω_{d,i}t), where ω_{d,i} is the damped natural frequency of the rotating structure. In some embodiments, the system is a tracking CSLDV system. In some embodiments, the system includes a camera, a scanner, and a single-point laser Doppler vibrometer. In some embodiments, the rotating structure is rotating at a non-constant speed. In some embodiments, the rotating structure is rotating at a constant speed. In some embodiments, the time interval is measured by the system from a first end of a scan path to a second end. In some embodiments, the method further includes determining end-to-end undamped mode shapes of the structure. In some embodiments, the method further includes determining a first normalized end-to-end undamped mode shape, a second normalized end-to end undamped mode shape, and/or a third normalized end-to-end undamped mode shape of the rotating structure. In some embodiment, the method further includes determining a first damped natural frequency, a second damped natural frequency, and/or a third damped natural frequency of the rotating structure. In some embodiments, measuring the response of the rotating structure is a non-contact method. In some embodiments, the response of the rotating structure is measured without the inclusion of a mark or encoder on the rotating structure. In some embodiments, measuring includes scanning along a 2D path on the rotating structure. In some embodiments, the rotating structure is a wind turbine blade.

Another modal analysis method, herein referred to as the “improved lifting method” was previously described in co-pending U.S. patent application Ser. No. 18/048,567, filed on Oct. 21, 2022 in the name of Weidong ZHU and Linfeng LYU, which is hereby incorporated by reference in its entirety herein. Briefly, the improved lifting method is based on a rigorous rotating beam vibration theory, and uses an image processing method and a modal parameter estimation method to estimate the rotation speed, modal parameters, and operation deflection shapes (ODSs) of a rotating structure under ambient excitation. A camera is used to capture images of the rotating structure so that a tracking CSLV system, e.g., a tracking CSLDV system, can track the structure by processing its images. Raw tracking CSLV measurements are transformed into measurements at multiple virtual measurement points using the improved lifting method. The improved lifting method can be used to estimate modal parameters of the rotating structure with a constant speed, including damped natural frequencies, undamped mode shapes, and modal damping ratios, by calculating and analyzing correlation functions between lifted measurements at virtual measurement points and a reference measurement point, and their power spectra. It can also be used to estimate ODSs of the rotating structure with a constant or prescribed time-varying speed.

One embodiment of the improved lifting method comprises: measuring a response of a rotating structure subject to random excitation with a system; interpolate positions of the response on a grid to generate a plurality of interpolated positions; rectifying the plurality of interpolated positions to create a plurality of rectified interpolated positions; identifying a plurality of zero-crossings from the plurality of rectified interpolated positions; determine a portion of the plurality of zero-crossings with a time increment; and interpolate and lift measurements at the portion of the plurality of zero-crossings. In some embodiments, rectifying the plurality of interpolated positions includes determining negative absolute values of differences between the plurality of interpolated positions and a position of a virtual measurement point on a scan path. In some embodiments, the time increment is equal to the inverse of a scan frequency. In some embodiments, the system is a tracking CSLDV system. In some embodiments, the system includes a camera, a scanner, and a single-point laser Doppler vibrometer. In some embodiments, the method includes capturing images of the rotating structure. In some embodiments, the method further includes determining a damped natural frequency, a damping ratio, and/or an undamped mode shape of the rotating structure. In some embodiments, the rotating structure is a wind turbine blade.

### Example 1—An Edge Detection Method Using a 2D Scan Scheme, Including Optionally Subtracting a Complex Background

### Methodology

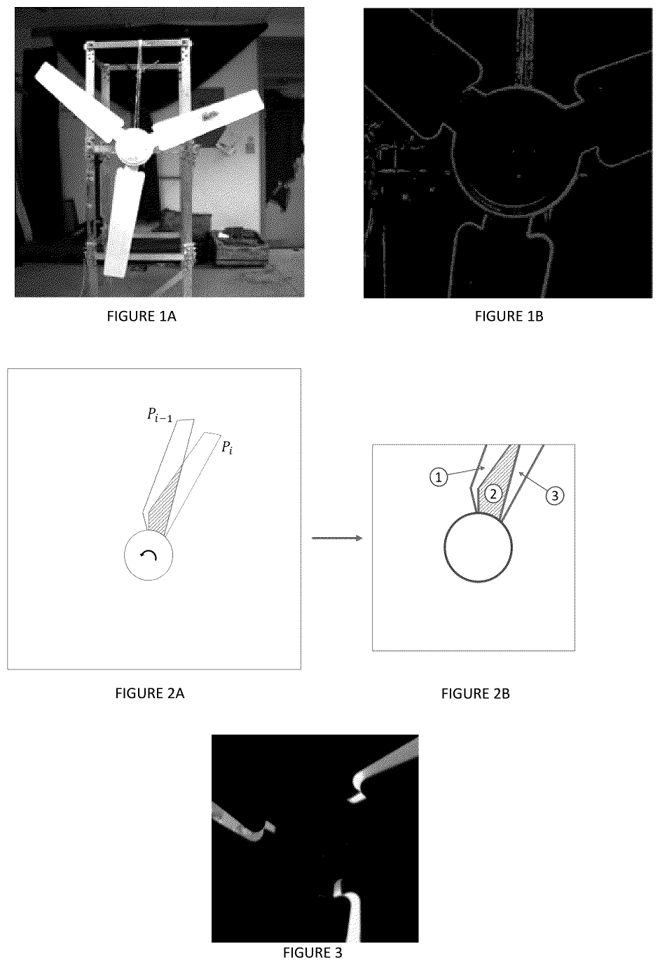

A background subtraction technique was implemented, wherein the black tarp in the proof of concept experiment is removed to mimic a complex background, which better replicates real-world settings, as shown in FIGS. 1A and 1B. It can be seen in FIG. 1B that edge detection alone shows edges of the fan and edges of the aluminum frame. Without removing the edges of the aluminum frame, edge detection does not provide an effective means of tracking the fan blades as they rotate. To remove all edges that do not constitute the edges of the fan blades, two consecutive video frames are used to form a differential frame by subtracting the previous frame from the current frame. The differential frame produced from this subtraction technique includes only the angular motion made by the rotating fan blades. Pixels in a frame that constitute stationary objects retain their intensity values throughout a video sequence. Since digital images are matrices, simple matrix subtraction removes all stationary objects in the frame. When the camera is stationary and the largest moving object in the frame is the rotating fan, this background subtraction technique is effective for isolating the edges of the rotating fan blades.

FIG. 2 shows an illustration of the working principle behind the background subtraction technique when considering two consecutive frames of a video sequence. Previous and current frames are denoted as Pᵢ₋₁ and Pᵢ, respectively. The frame rate of the camera is sufficiently higher than the rotation speed of the fan. This allows small angular motions to be determined between two consecutive frames that are indicated by shaded regions in FIGS. 2A-2B. The extracted sub-frame is shown in FIG. 2B to depict portions of the blade that are retained and removed in the differential frame. In this example, the fan rotates in the counterclockwise direction in view of the camera, as indicated by the arrow in FIG. 2A. The region of the blade labeled as (1) in FIG. 2B denotes the blade's positive angular motion. This is the region of the blade that is shown in the differential frame. Region (2) in FIG. 2B is the portion of overlapping blade positions between the current and previous frames, and the region denoted by (3) is the position of the blade in the previous frame. As previously stated, pixels that retain their intensity values between frames are removed when matrix subtraction is applied. This causes region (2) to be removed in the differential frame. Region (3) is removed due to the difference in color between the blade and background. Region (3) in FIG. 2B is the position of the blade in the previous frame, which has high pixel intensities. In the current frame, the blade is no longer in this position, and the pixel intensities are now those that constitute the background, i.e., lower intensity values. When matrix subtraction is applied, region (3) in the differential frame theoretically consists of negative intensity values. Since pixels cannot have negative values, region (3) is occupied by intensity values of zero instead of negative values. Because of this, region (3) is removed in the differential frame. FIG. 3 shows that edges of the aluminum frame are removed while the angular motion of the blades is retained.

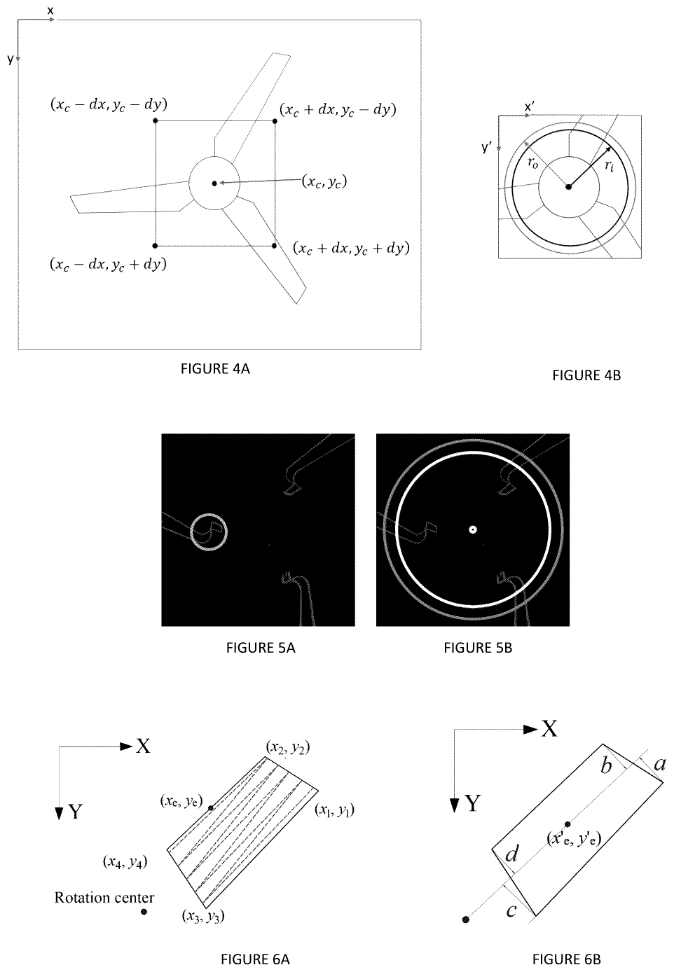

Selecting dimensions of the sub-frame and values of radial bounds that are used for the distance condition discussed in Ref. [7] is up to the user, but some guidelines should be followed to ensure optimal performance. Using the sub-frame in this algorithm is motivated by a reduction in computational time, but there is a minimum size that can be selected so that the algorithm still performs as expected. The sub-frame is constructed using coordinates of the rotation center with two transformation constants (dx and dy) whose values are specified by the user. The illustration in FIG. 4A shows sub-frame dimensions constructed using rotation center coordinates in the XY coordinate system and transformation constants.

The transformation constants were chosen to be equal so that the sub-frame is a square, but it should be appreciated that the shape of the sub-frame is not limited to that of a square, as understood by the person skilled in the art. The sub-frame is then defined by new axes X′ and Y′, and radial bounds are defined relative to rotation center coordinates, which is located at the center of the sub-frame, i.e.,

$$( \frac{{x}^{′}}{2} , \frac{{y}^{′}}{2} ) .$$

The radial bounds in FIG. 4B are defined by radius values and can be chosen so that the radius of the outer radial bound (rₒ) can be less than half the value of the sub-frame dimension

$$( i . e . , {r}_{o} < \frac{{y}^{′}}{2} ) .$$

The radius of the inner radial bound can be chosen to be less than the outer radial bound, but greater than any portion of the blades that has a non-uniform profile, which is typically a change in geometry near the point of attachment between the fan blades and center hub. FIG. 5A labels a point of non-uniform blade geometry that was considered when selecting values for the radial bounds in FIG. 5B.

When the algorithm runs in real time, the average location of edges around a detected edge is used as the current position of a fan blade. The actual position of the fan blade differs slightly from its calculated position due to some latency, but when the position is used to control the tracking CSLDV system, a phase angle is incorporated that allows the laser spot position to be adjusted so that the laser spot remains on the fan blade as it rotates.

Once the position of an edge is determined, whether using the method described herein or some other method, a 2D zigzag scan path (referred to herein as the “2D scan scheme”) can be generated on the rotating fan blade. Using (xₑ, yₑ) as the coordinates of the detected edge of the rotating fan blade and (x₁, y₁), (x₂, y₂), (x₃, y₃), and (x₄, y₄) as the coordinates of the four corners of the fan blade, the 2D scan path is generated (FIG. 6A). Note that the schematic of the rotating fan blade in FIG. 6 has a general quadrilateral shape to demonstrate the scan scheme on an arbitrary quadrilateral rotating blade. Once (xₑ, yₑ) is determined by the robust edge detection method. (xₑ, yₑ) can be shifted to (x′ₑ, y′ₑ), which is within the boundary of the blade (FIG. 6B), by

$$\{ \begin{matrix}{x}_{e}^{′} = {x}_{c} + C [ ( {x}_{e} - {x}_{c} ) cos ( θ ) + ( {y}_{e} - {y}_{c} ) sin ( θ ) ] \\ {y}_{e}^{′} = {y}_{c} + C [ - ( {x}_{e} - {x}_{c} ) sin ( θ ) + ( {y}_{e} - {y}_{c} ) cos ( θ ) ]\end{matrix} \qquad ( 8 )$$

where C is a constant that is used to adjust the distance between (x_{c}, y_{c}) and (x′ₑ, y′ₑ), and θ is the angle between the line that passes through (x_{c}, y_{c}) and (xₑ, yₑ) and the line that passes through (x_{c}, y_{c}) and (x′ₑ, y′ₑ). The distance between (x′ₑ, y′ₑ) and (x_{c}, y_{c}) is calculated by r=\sqrt{(x′ₑ−x_{c})²+ (y′ₑ−y_{c})²}. Once C and θ are fixed, one can calculate coordinates of four corners of the rotating blade based on its geometry. Coordinates of projections of four corners of the rotating blade on the line that passes though (x_{c}, y_{c}) and (x′ₑ, y′ₑ) can be determined since (x_{c}, y_{c}) and (x′ₑ, y′ₑ) are known. By setting distances between projections of four corners of the rotating blade and (x_{c}, y_{c}) as s₁, s₂, s₃, and s₄, respectively, and distances between four corners of the rotating blade and the line that passes though (x_{c}, y_{c}) and (x′ₑ, y′ₑ) as a, b, c, and d, respectively, the coordinates of the four corners can be calculated by

$$\{ \begin{matrix}{x}_{1} = {x}_{c} + {s}_{1} ( {x}_{e}^{′} - {x}_{c} ) / r + a ( {y}_{e}^{′} - {y}_{c} ) / r \\ {y}_{1} = {y}_{c} + {s}_{1} ( {y}_{e}^{′} - {y}_{c} ) / r - a ( {x}_{e}^{′} - {x}_{c} ) / r\end{matrix} \qquad ( 9 )$$

$$\{ \begin{matrix}{x}_{2} = {x}_{c} + {s}_{2} ( {x}_{e}^{′} - {x}_{c} ) / r - b ( {y}_{e}^{′} - {y}_{c} ) / r \\ {y}_{2} = {y}_{c} + {s}_{2} ( {x}_{e}^{′} - {x}_{c} ) / r + b ( {x}_{e}^{′} - {x}_{c} ) / r\end{matrix} \qquad ( 10 )$$

$$\{ \begin{matrix}{x}_{3} = {x}_{c} + {s}_{3} ( {x}_{e}^{′} - {x}_{c} ) / r + c ( {y}_{e}^{′} - {y}_{c} ) / r \\ {y}_{3} = {y}_{c} + {s}_{3} ( {x}_{e}^{′} - {x}_{c} ) / r - c ( {x}_{e}^{′} - {x}_{c} ) / r\end{matrix} \qquad ( 11 )$$

$$\{ \begin{matrix}{x}_{4} = {x}_{c} + {s}_{4} ( {x}_{e}^{′} - {x}_{c} ) / r - d ( {y}_{e}^{′} - {y}_{c} ) / r \\ {y}_{4} = {y}_{c} + {s}_{4} ( {x}_{e}^{′} - {x}_{c} ) / r + d ( {x}_{e}^{′} - {x}_{c} ) / r\end{matrix} \qquad ( 12 )$$

The zigzag scan path in FIG. 6A is a combination of multiple straight lines. The laser spot of the image-based tracking CSLDV system is swept on each line for an odd number of times when tracking and scanning the rotating blade. Coordinates of four corners of the rotating blade can be used to generate end points of the current line swept by the laser spot. The 2D scan scheme uses four distances to control positions of four boundary points of a 2D scan path, which is more intuitive than the 2D scan scheme in Ref. [8] that uses four angles to control positions of four boundary points of a 2D scan path.

The laser spot is arranged to sweep N lines and the coordinates of end points of the i-th line (xᵢ¹, yᵢ¹) and (xᵢ², yᵢ²) can be determined by

$$\{ \begin{matrix}{x}_{i}^{1} = {y}_{2} + \frac{2 ( {x}_{1} - {x}_{2} )}{N - 1} ( \frac{N - i}{2} ) \\ {y}_{i}^{1} = {y}_{2} + \frac{2 ( {y}_{1} - {y}_{2} )}{N - 1} ( \frac{N - i}{2} )\end{matrix} \qquad ( 13 )$$

$$\{ \begin{matrix}{x}_{i}^{2} = {x}_{4} + \frac{2 ( {x}_{3} - {x}_{4} )}{N - 1} ( \frac{N - i}{2} ) \\ {y}_{i}^{2} = {y}_{4} + \frac{2 ( {y}_{3} - {y}_{4} )}{N - 1} ( \frac{N - i}{2} )\end{matrix} \qquad ( 14 )$$

when i is odd, and

$$\{ \begin{matrix}{x}_{i}^{1} = {y}_{2} + \frac{2 ( {x}_{1} - {x}_{2} )}{N - 1} ( \frac{N - i - 1}{2} ) \\ {y}_{i}^{1} = {y}_{2} + \frac{2 ( {y}_{1} - {y}_{2} )}{N - 1} ( \frac{N - i - 1}{2} )\end{matrix} \qquad ( 15 )$$

$$\{ \begin{matrix}{x}_{i}^{2} = {x}_{4} + \frac{2 ( {x}_{3} - {x}_{4} )}{N - 1} ( \frac{N - i + 1}{2} ) \\ {y}_{i}^{2} = {y}_{4} + \frac{2 ( {y}_{3} - {y}_{4} )}{N - 1} ( \frac{N - i + 1}{2} )\end{matrix} \qquad ( 16 )$$

when i is even. The laser spot is swept between (xᵢ¹, yᵢ¹) and (xᵢ², yᵢ²) when the image-based tracking CSLV system tracks the rotating blade. The image-based tracking CSLDV system measures responses of the rotating blade when tracking and scanning it, and a modal analysis method, e.g., an improved demodulation method based on a non-uniform rotating plate vibration theory in Ref. [8], can process measured responses to obtain full-field undamped mode shapes of the rotating blade.

Measured (xₑ>yₑ) are also used to estimate the real-time rotation speed of the blade. By assigning (xₑ (t₁), yₑ (t₁)) and (xₑ (t₂), yₑ (t₂)) as estimated edge positions at time instants t₁ and t₂, the rotation speed of the rotating blade can be calculated by

$$( 17 )$$

$$R = \frac{1}{{t}_{2} - {t}_{1}} arc \text{} cos ( \text{} \frac{( {x}_{e} ( {t}_{1} ) - {x}_{c} ) ( {x}_{e} ( {t}_{2} ) - {x}_{c} ) + ( {y}_{e} ( {t}_{1} ) - {y}_{c} ) ( {y}_{e} ( {t}_{2} ) - {y}_{c} )}{\sqrt{[ {( {x}_{e} ( {t}_{1} ) - {x}_{c} )}^{2} + {( {y}_{e} ( {t}_{1} ) - {y}_{c} )}^{2} ] [ {( {x}_{e} ( {t}_{2} ) - {x}_{c} )}^{2} + {( {y}_{e} ( {t}_{2} ) - {y}_{c} )}^{2} ]}} )$$

In some embodiments of the first aspect, the method of detecting or identifying edges of a rotating structure for an image-based tracking system can include determining real-time positions of points on edges of the rotating structure by processing images captured by the image-based tracking system and using the image-based tracking system to scan at least a portion of a surface of the rotating structure using a 2D scan scheme, wherein the method is performed without attaching any mark or encoder to the rotating structure, and wherein the method further comprises extracting edges of the rotating structure from a complex background by processing images of the rotating structure.

Although not described herein, it should be appreciated that in some embodiments of the first aspect, the method of detecting or identifying edges of a rotating structure for an image-based tracking system can include determining real-time positions of points on edges of the rotating structure by processing images captured by the image-based tracking system and using the image-based tracking system to scan at least a portion of a surface of the rotating structure using a 1D scan scheme, wherein the method is performed without attaching any mark or encoder to the rotating structure, and wherein the method further comprises extracting edges of the rotating structure from a complex background by processing images of the rotating structure.

### Experimental Setup

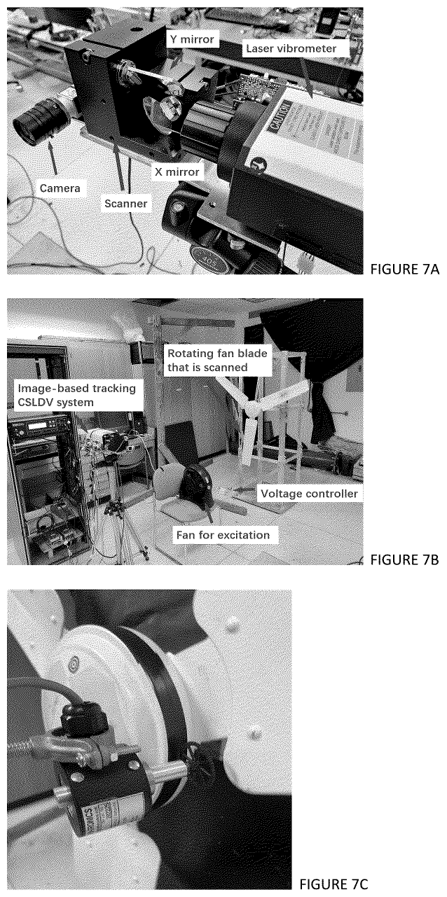

An example of an image-based tracking CSLDV is shown in FIG. 7A, which comprises a Polytec OFV-353 single-point laser vibrometer, a Cambridge 6240H scanner with a set of orthogonal mirrors, and a Basler acA2040-90 um camera. The experimental setup of tracking and full-field scanning of a rotating fan blade under random excitation is shown in FIG. 7B. The fan comprising the fan blades was mounted on a frame with a hub height of 123.5 cm. The blade that was tracked and scanned by the image-based tracking CSLDV system was covered by a reflective tape so that the signal-to-noise ratio of measurement of the image-based tracking CSLDV system was sufficiently high. The frame and the wall behind it could provide a complex background to all images captured by the camera (FIG. 7B). The image-based tracking CSLDV system was mounted on a tripod with a height of 116.6 cm. The distance between mirrors of the image-based tracking CSLDV system and the fan comprising the fan blades was 173.8 cm. A small fan that was 92 cm away from the fan comprising the fan blades was used to excite the fan blades by its air flow. The air flow of the small fan could be considered as random excitation applied to the fan blades. The camera captured images of the fan blades with a frame rate of 50 frames per second. When the fan blades were stationary, the position of a fan blade could be easily determined in an image of the fan blades. A prescribed stationary 2D scan scheme could be generated on the fan blade so that the image-based tracking CSLDV system could scan its whole surface. When the fan blades were rotated at a constant speed, the camera kept capturing images. When an image of the rotating fan blades was captured, the complex background could be removed and the position of an edge of a rotating fan blade determined. The position was shifted to a position on the middle line of the rotating fan blade. The 2D scan scheme described herein calculated positions of four corners of the fan blade that was scanned and determined endpoints of the line that the laser spot was swept on. Angular positions of orthogonal mirrors of the scanner were considered to be linearly related to X and Y positions of the laser spot when rotation angles of orthogonal mirrors were small. Orthogonal mirrors of the scanner were controlled to rotate by an NI9149 controller to change the position of the laser spot based on positions of end points of the line. A fan speed controller was used to let the fan blades rotate with different constant speeds. A rotary encoder that was attached to the fan hub was used to validate the edge detection method by comparing estimated rotation speeds of the fan blade from the edge detection method and rotary encoder (FIG. 7C). The image-based tracking CSLDV system could track and scan the rotating fan blades whose speed was between 0-40 revolutions per minute (rpm); therefore it can easily track and scan a rotating wind turbine blade with a speed of 5-15 rpm [10]. The camera optical axis in the current experiment setup in a laboratory setting is relatively close to the rotation axis of the fan comprising the fan blades; so misalignment between the camera optical axis and the rotation axis of the fan comprising the fan blades is small and negligible. For a field test of a large wind turbine blade, the misalignment issue can depend on the position of the camera relative to the wind turbine. For the case when there is large misalignment between the camera optical axis and the rotation axis of the blade, the edge detection method can be improved by compensating the effect of perspective projections that can cause misalignment. The improved edge detection method can be integrated into the current image-based tracking CSLV system to measure vibrations of real wind turbine blades.

### Edge Detection Results

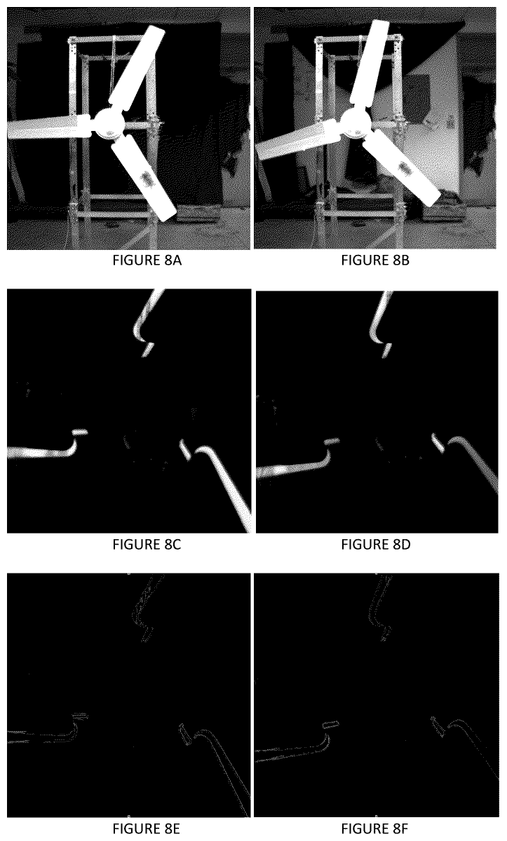

To validate the robustness of the edge detection method described in this example, the fan blades were rotated with a constant speed. The edge detection method was used to track a rotating fan blade and estimate its rotation speed with the black tarp covering versus not covering (i.e., removed) the wall behind the frame (see, e.g., FIGS. 8A and 8B, respectively). Estimated speeds of the rotating fan blades with the black tarp covering versus not covering the wall were compared. Images of the rotating fan blades with a constant speed captured by the camera in the image-based tracking CSLDV system are shown in FIGS. 8A and 8B. Differential frames obtained from images captured by the camera are shown in FIGS. 8C and 8D, where edges of the rotating fan blades are clearly shown while backgrounds are basically removed. Sobel detector was applied to FIGS. 8C and 8D and their resultant edge maps are shown in FIGS. 8E and 8F, respectively. Edge positions could be easily determined in both edge maps in FIG. 8 by the robust edge detection method described herein. Note that edges of all three blades of the rotating fan blades are shown in the edge maps. To track the position of one blade of the rotating fan, one needs to use a distance condition, for example as described in Ref. [7].

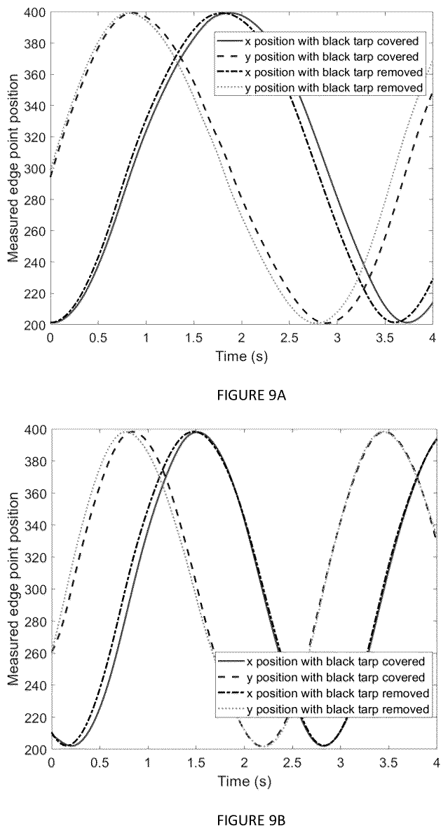

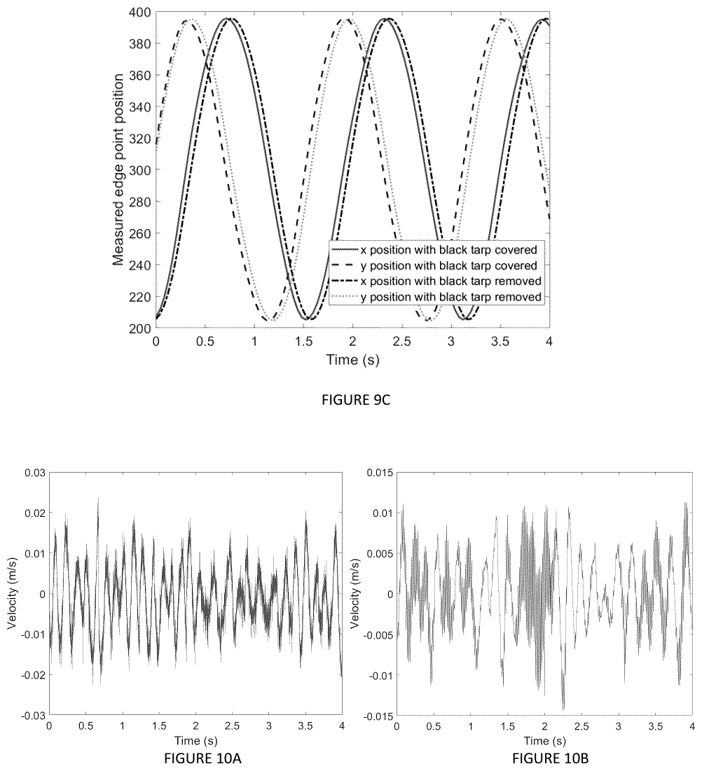

Estimated edge positions in the X′Y′ coordinate system of a rotating fan blade with low, medium, and high constant speeds are shown in FIGS. 9A-C. Plots were shifted to minimize phase differences between edge positions with the black tarp covering the wall and edge positions with the black tarp not covering the wall (i.e., removed). Estimated edge positions of the rotating fan blade with the black tarp covering and not covering are close to each other, which means that backgrounds of images captured by the camera did not affect tracking of the rotating fan blade. Calculated average rotation speeds and errors between rotation speeds with the black tarp covering and removed are listed in Table 1. One can see that the error between estimated low rotation speeds with the black tarp covering and removed is larger than the error between estimated high rotation speeds. Without being bound by theory, it is believed that this is because the blades of the rotating fan were not in balance since the blade was covered with a reflective tape, and the fan could not fully maintain a constant low speed due to insufficient power that was controlled by the fan speed controller, which caused a larger error between estimated lower rotation speeds with the black tarp covering versus removed. Estimated speeds of the rotating fan blade from the edge detection method and rotary encoder are shown in Table 2, which are close.

TABLE 1
Estimated speeds of the rotating fan blade with different
constant speeds and black tarp covering versus removed

| Speed | Low | Medium | High |
|---|---|---|---|
| Black tarp covered | 16.24 rpm | 22.90 rpm | 37.53 rpm |
| Black tarp removed | 16.69 rpm | 22.46 rpm | 37.50 rpm |
| Error | 2.8% | 1.9% | 0.08% |

TABLE 2
Estimated speeds of the rotating fan blade using
the edge detection method and rotary encoder

| Fan speed | Edge detection | Encoder | Difference |
|---|---|---|---|
| Low | 18.56 rpm | 18.44 rpm | 0.65% |
| High | 36.67 rpm | 37.06 rpm | 1.05% |

### Results

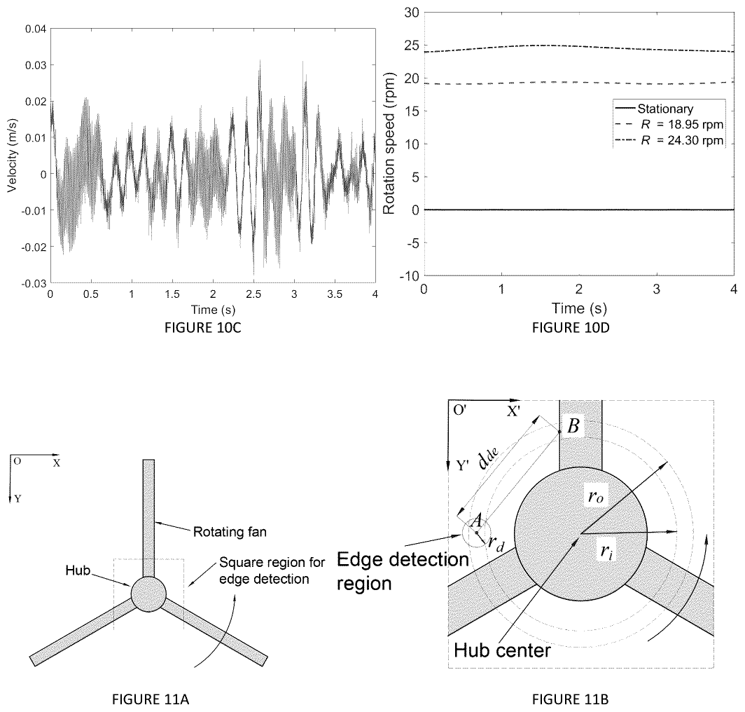

The 2D scan path that was used to scan the whole surface of the fan blade consisted of 30 lines, and the laser spot was swept along each line 5 times when tracking and scanning the fan blade. It should be appreciated by the person skilled in the art that the number of scanned lines can be more or less than the 30 lines and the number of times the laser spot is swept can be more or less than 5 times, as understood by the person skilled in the art. Measured responses of the image-based tracking CSLDV system when the fan blades were stationary and had two constant speeds R=18.95 rpm and R=24.30 rpm were used to estimate modal parameters of the fan blade. Measured responses of the stationary fan blade and the rotating fan blade with R=18.95 rpm and R=24.30 rpm are shown in FIGS. 10A, 10B, and 10C, respectively. Note that measured responses of the rotating fan blades in FIGS. 10B and 10C were preprocessed by a high-pass filter to remove pseudo vibrations introduced by rotation. Estimated real-time speeds of the stationary fan blade and the rotating fan blade with R=18.95 rpm and R=24.30 rpm are shown in FIG. 10D. The fast Fourier transform was applied to the measured response of a fan blade to estimate its damped natural frequencies. The first two damped natural frequencies of the stationary fan blade and the rotating fan blade with R=18.95 rpm and R=24.30 rpm are shown in Table 3. One can see that damped natural frequencies got higher when the fan blade rotated with a higher speed, which was believed to be caused by the centrifugal stiffening effect from rotation of the fan blade.

TABLE 3
Estimated damped natural frequencies of the rotating
fan blade with different constant speeds

| Rotation speed | Stationary | 18.95 rpm | 24.30 rpm |
|---|---|---|---|
| First damped natural | 6.40 | 6.75 | 6.90 |
| frequency (Hz) | | | |
| Second damped | 28.50 | 29.12 | 29.40 |
| natural frequency (Hz) | | | |

In some embodiments, an improved demodulation method based on a non-uniform rotating plate vibration theory in Ref. [8], and as described hereinbelow, can be used to process measurements of an image-based tracking CSLV system, e.g., a tracking CSLDV system. Although not shown herein, undamped full-field mode shapes of the rotating fan blade were similar to the first two undamped bending mode shapes of a cantilever plate since the rotating fan blade is similar to a rotating cantilever plate whose one side is fixed at the fan hub. Vibrations corresponding to higher modes of the rotating fan blade have low signal-to-noise ratios in measurements of the image-based tracking CSLDV system, which requires the system to sweep its laser spot along each line many times so that some random noise can be removed by signal averaging and signal-to-noise ratios can be increased. This can greatly increase amounts of measurement data of the image-based tracking CSLDV system, which can greatly increase times for testing and signal processing. Therefore, only the first two modes of the rotating fan blade were estimated. The image-based tracking CSLDV system can estimate bending and torsional modes of a rotating wind turbine blade.

In some embodiments, an improved lifting method can be used to process measurements of an image-based tracking CSLV system, e.g., a tracking CSLDV system.

In conclusion, a robust edge detection method for an image-based tracking CSLV system, e.g., a CSLDV system, to track and scan a rotating structure is described. The edge detection method can further comprise the extraction of a complex background. A 2D scan scheme was developed that can generate a zigzag scan path on the surface of the rotating structure based on the position of the edge. The laser spot of the image-based tracking CSLV system is swept along the 2D scan path to measure vibration of the rotating structure. Although not discussed in this example, a 1D scan scheme can be used to measure vibration of the rotating structure. In some embodiments, an improved demodulation method can be used to estimate modal parameters, such as damped modal parameters and undamped mode shapes, of the rotating structure. In other embodiments, an improved lifting method can be used to estimate modal parameters. Experimental validation of the robust edge detection method was conducted by tracking a rotating fan blade with a complex background and estimating the position of its edge as well as its rotation speed. An image-based tracking CSLDV system was used to estimate modal parameters of the stationary fan blade and the rotating fan blade with constant speeds. The first two damped natural frequencies and full-field undamped mode shapes of the stationary fan blade and the rotating fan blade with different constant speeds were successfully estimated. Accordingly, the image-based tracking CSLV system described in the first example can be used to track and scan actual wind turbine blades and monitor their vibrations.

### Example 2—an Edge Detection Method Using a 1D Scan Scheme

### Methodology

The edge detection method of this example can track a rotating structure so that the tracking CSLV system, e.g., a tracking CSLDV system, can scan on it. A rotating fan was used as a model of a horizontal-axis wind turbine (FIG. 11A). Image processing modules in the LabVIEW software were used to process images captured by the camera in the tracking CSLDV system to identify edges of the rotating fan blades. A coordinate system O-XY was used in the captured image of the rotating fan blades in FIG. 11A, where the origin O is located at the upper left corner of the image. Edge detection was performed on a square region around the center of rotation that was subtracted from the original image to facilitate image processing (FIG. 11A), and the geometric center of the square region is the hub center (FIG. 11B). A coordinate system O′-X′Y′ was used in the square region where the origin O′ is located at the upper left corner of the square region (FIG. 11B).

A distance condition was used with a point for edge detection that is the center of a circle edge detection region, which is shown as point A in FIG. 11B, in the square region to detect an edge of a rotating fan blade that passes through point A. An annulus in FIG. 11B whose center is the hub center was used to determine a point on the edge of the rotating fan blade, which is shown as point B in FIG. 11B, that meets the distance condition, and point A is in the annulus. The inner and outer radii of the annulus are rᵢ and rₒ, respectively, and rᵢ and rₒ can be larger than the radius of the fan hub so that the edge detection method can always track an edge point of the rotating fan blade instead of an edge point on the fan hub. When the position of point B in the square region is (X′ₑ, Y′ₑ), the position of point A in the square region is (X′_{d}, Y′_{d}), and the position of the hub center is (X′_{c}, Y′_{c}), one has

$${r}_{i} < \sqrt{{( {X}_{e}^{′} - {X}_{c}^{′} )}^{2} + {( {Y}_{e}^{′} - {Y}_{c}^{′} )}^{2}} < {r}_{o} {r}_{i} < \sqrt{{( {X}_{d}^{′} - {X}_{c}^{′} )}^{2} + {( {Y}_{d}^{′} - {Y}_{c}^{′} )}^{2}} < {r}_{o} \qquad ( 18 )$$

All spatial positions measured by the camera in the tracking CSLDV system are represented by pixel numbers, and (X′_{c}, Y′_{c}) can be easily determined by IMAQ Find Circles VI in LabVIEW since it is the hub center position and the boundary of the hub is a circle. The radius of the edge detection region in FIG. 11B is r_{d}, and the distance condition to detect any fan blade edge that passes the point for edge detection is

$${d}_{de} < {r}_{d} \qquad ( 19 )$$

$$where$$

$${d}_{de} = \sqrt{{( {X}_{e}^{′} - {X}_{d}^{′} )}^{2} + {( {Y}_{e}^{′} - {Y}_{d}^{′} )}^{2}} \qquad ( 20 )$$

which is the distance between point A and point B, as shown in FIG. 11B. Before the tracking CSLV system starts to track and scan the rotating fan blade, the edge detection method calculates distances between point A and all edge points of blades of the rotating fan in the annulus. Once point B meets the distance condition in Eq. (19), point B is tracked by updating the position of point A with the position of point B. Since the updated point A is an edge point, points that satisfy the updated distance condition are still on the same edge, and the tracking CSLV system can track the edge when the fan blades rotate. Note that tracking and scanning of the tracking CSLV system are based on spatial positions in original images, one needs to convert the position of point B that is selected to be tracked from the coordinate system in the square region to the position in the coordinate system in the original image using the following relations:

$${X}_{e} = {X}_{e}^{′} + {X}_{c} - {X}_{c}^{′} {Y}_{e} = {Y}_{e}^{′} + {Y}_{c} - {Y}_{c}^{′} \qquad ( 21 )$$

where Xₑ and Yₑ are positions of point B in the original image along X and Y directions, respectively, and X_{c} and Y_{c} are positions of the hub center in the original image along X and Y directions that are determined by IMAQ Find Circles VI in LabVIEW, respectively.

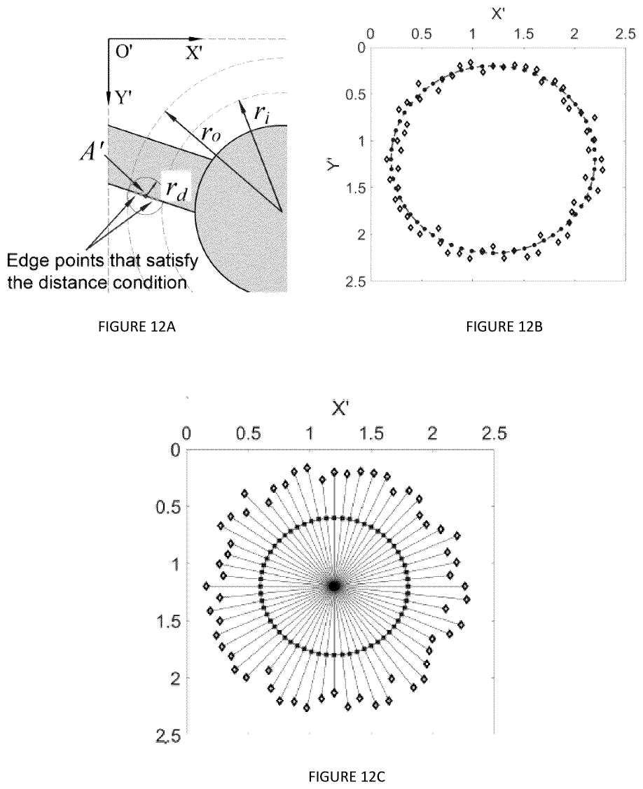

Once point A is updated with point B, which is shown as point A′ in FIG. 12A, measured edge point positions will experience jitter inside the distance condition because there are many edge points that meet the distance condition (FIG. 12A). This causes edge point positions to have variation in the radial distance to the hub center (FIG. 12B). Small dots on the smooth dashed circle in FIG. 12B are simulated ideal edge point positions when the fan blades rotate with a constant speed, and diamonds near the smooth dashed circle in FIG. 12B are simulated edge point positions measured by the tracking CSLV system with the jitter effect when the fan blades rotate with a constant speed. To smoothly scan the rotating fan blade, the jitter effect needs to be removed. Since blades of the rotating fan are along radial directions of the fan hub, angular positions of edge points in the edge detection region in FIG. 12A with respect to the hub center can be considered the same if rᵢ and rₒ are close to each other. Therefore, angular positions of the edge points can be used to reconstruct edge point positions on a smooth circle. Let a reconstructed edge point position corresponding to the measured edge point position (X′ₑ, Y′ₑ) in the square region be (X′ᵣ, Y′ᵣ); one has

$${X}_{r}^{′} = {X}_{c}^{′} + c cos ( α ) {Y}_{r}^{′} = {Y}_{c}^{′} + c sin ( α ) \qquad ( 22 )$$

where c is a positive constant coefficient and

$$α = arc tan ( \frac{{Y}_{e}^{′} - {Y}_{c}^{′}}{{X}_{e}^{′} - {X}_{c}^{′}} ) \qquad ( 23 )$$

Simulated reconstructed edge point positions on a smooth circle are shown in FIG. 12C with squares, and their corresponding simulated edge point positions that were measured by the tracking CSLV system with the jitter effect are shown in FIG. 12C with diamonds.

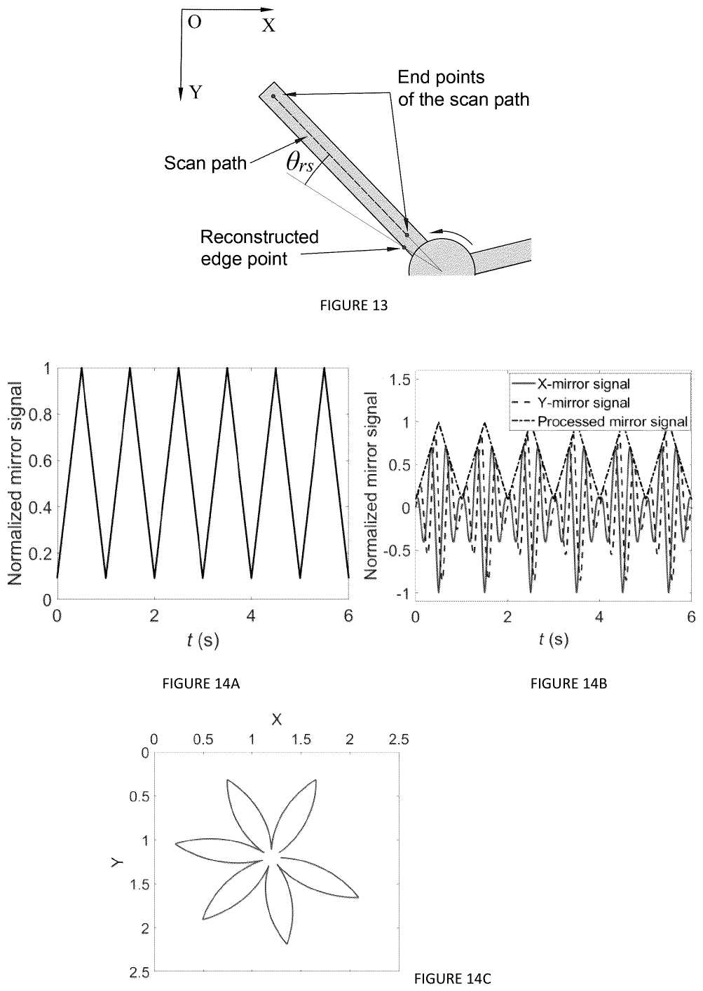

Reconstructed edge point positions were used to generate scan paths on the rotating fan blade using a 1D scan scheme described below. Assigning (Xᵣ, Yᵣ) as the reconstructed edge point position in the original image that is obtained by Eq. (21) and θᵣₛ as the angle between the line passing through the fan hub center and (Xᵣ, Yᵣ) and the line in the middle of the rotating fan blade (FIG. 13), the reconstructed edge point position can be shifted to a position on the line in the middle of the rotating fan blade by

$${X}_{s} = {X}_{c} + ( {X}_{r} - {X}_{c} ) cos ( {θ}_{rs} ) + ( {Y}_{r} - {Y}_{c} ) sin ( {θ}_{rs} ) \qquad ( 24 )$$

$${Y}_{s} = {Y}_{c} - ( {Y}_{r} - {Y}_{c} ) sin ( {θ}_{rs} ) + ( {X}_{r} - {X}_{c} ) cos ( {θ}_{rs} )$$

End point positions of the scan path in the middle of the rotating fan blade are represented by

$${X}_{up} = {X}_{c} + {k}_{up} ( {X}_{s} - {X}_{c} ) {Y}_{up} = {Y}_{c} + {k}_{up} ( {Y}_{s} - {Y}_{c} ) \qquad ( 25 )$$

$${X}_{down} = {X}_{c} + {k}_{down} ( {X}_{s} - {X}_{c} ) {Y}_{down} = {Y}_{c} + {Y}_{down} ( {Y}_{s} - {Y}_{c} ) \qquad ( 26 )$$

where (Xᵤₚ, Yᵤₚ) is the position of the end point of the scan path near the tip of the rotating fan blade, (X_{down}, Y_{down}) is the position of the end point of the scan path near the hub of the rotating fan blade, and kᵤₚ and k_{down} are two constant coefficients. Once end point positions of the scan path are determined, the tracking CSLDV system can sweep its laser spot on the scan path.

The scan path generated on the rotating fan blade is a straight line (FIG. 13). Mirror signals of a CSLV system are considered linearly related to laser spot positions when scanning a structure. When a CSLV system, e.g., a CSLDV system, is used to scan a straight path on a stationary structure, feedback signals of mirrors in the CSLV system are zigzag lines (FIG. 14A) since the laser spot of the CSLV system moves on the straight line. These mirror signals can be directly used to represent laser spot positions that can be used to obtain mode shapes on the scan path [9]. However, X- and Y-mirror signals of the tracking CSLV system when scanning a straight path on a rotating structure are not zigzag lines (FIG. 14B) since the laser spot of the tracking CSLV system moves on a curved line due to rotation of the structure (FIG. 14C). These mirror signals cannot be used to represent laser spot positions. Therefore, mirror signals of the tracking CSLV system when scanning a rotating structure need to be processed to obtain zigzag mirror signals. A method is described here to process X- and Y-mirror signals to describe laser spot positions on the scan path and obtain rotation speeds of the structure.

Since the scan path is a straight line that passes through the hub center, the distance between the laser spot and hub center is linearly related to the spatial position of the laser spot on the scan path. Therefore, the distance between the laser spot and hub center can be used to describe the spatial position of the laser spot on the scan path. Let Xₗ(t) and Yₗ(t) be X- and Y-mirror signals of the tracking CSLV system at time t and X- and Y-mirror signals when the laser spot is at the hub center be zero, wherein the distance between the laser spot and hub center is

$${d}_{s} ( t ) = \sqrt{{( {X}_{l} ( t ) )}^{2} + {( {Y}_{l} ( t ) )}^{2}} \qquad ( 27 )$$

which is a zigzag line, as shown by the dashed line in FIG. 14B. Mirror signals are also used to obtain the rotation speed of the rotating fan blade by calculating the derivative of the polar angle of the point (Xₗ(t), Yₗ(t)) in a polar coordinate system. The angle of (Xₗ(t), Yₗ(t)) in the polar coordinate system whose pole is at the hub center and whose polar axis is along the X direction is

$$θ ( t ) = arc tan 2 ( {Y}_{l} ( t ) , {X}_{l} ( t ) ) \qquad ( 28 )$$

and the rotation speed of the fan blade in revolutions per minute (rpm) is

$$R ( t ) = \frac{30}{π} \frac{d θ ( t )}{d t} \qquad ( 29 )$$

### Experimental Setup

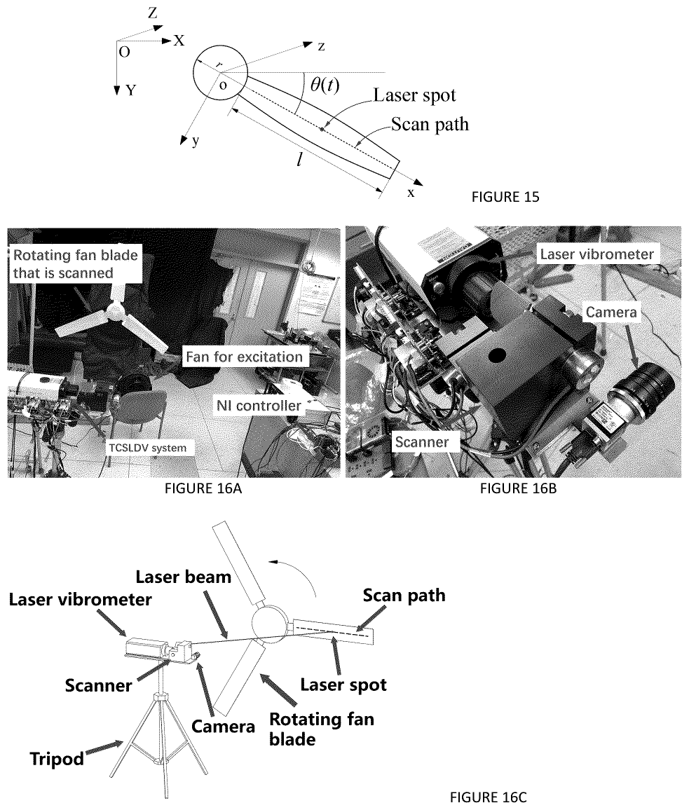

The experimental setup of tracking and scanning a rotating fan blade using the tracking CSLDV system is shown in FIG. 16A. The rotating fan comprising fan blades was mounted on a stationary frame, and its hub had a height of 122.3 cm. The tracking CSLDV system was mounted on a tripod with a height of 141.1 cm. The distance between the tracking CSLDV system and the rotating fan comprising fan blades was 176.4 cm. A small fan 94.6 cm away from the rotating fan comprising fan blades was used to excite the rotating fan blade by its air flow. The tracking CSLDV system consists of a Polytec OFV-353 single-point laser vibrometer, a Cambridge 6240H scanner, and a Basler acA2040-90 um camera whose max frame rate is 50 frames per second (FIG. 16B). The camera captured images of the fan blades when they rotated with a constant frame rate. Every time an image of the rotating fan blades was captured, the image was processed by the edge detection method described in this example to determine the position of a point on a fan blade edge. A scan path was generated on the fan blade once the position of the fan blade edge point was determined, and the tracking CSLDV system swept its laser spot along the scan path (FIG. 16C). A voltage controller was connected to the rotating fan to let it rotate with different constant speeds. Note that the fan can also rotate with a non-constant speed if one rotates it to an unbalanced position and releases it, since blades of the fan have different weights due to the additional mass of the reflective tape attached to the fan blade that is tracked and scanned by the tracking CSLDV system. The tracking CSLDV system can track the rotating fan blade with a speed between 0-40 rpm, while a large horizontal-axis wind turbine has a rotation speed between 5-15 rpm.

### Edge Detection Results

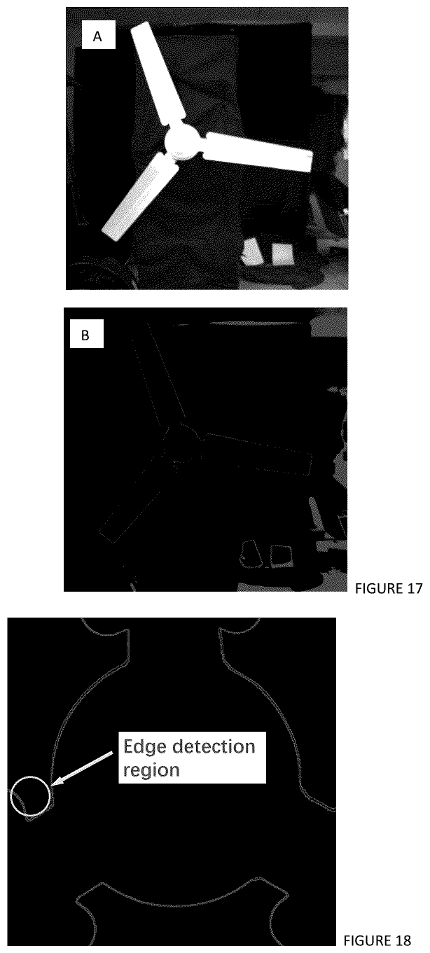

The fan comprising the fan blades was rotated with three different constant speeds R=18.13, 27.72, and 38.45 rpm, and then it was turned off and released from an unbalanced position to rotate with a nonconstant speed. The camera in the tracking CSLDV system captured images of the rotating fan blades with a pixel resolution of 2048×2048 and a frame rate of 50 frames per second. An image captured by the camera when the fan blades rotated is shown in FIG. 17A and a processed image that correspond to the image in FIG. 17A is shown in FIG. 17B, wherein edges of the rotating fan blades can be easily identified in the processed image.

A square region whose pixel resolution was 350×350 was extracted from the processed image to determine the position of an edge point to track (FIG. 18). The edge detection region is shown as a circle in FIG. 18 whose center coordinates are (25, 190). Note that the radius of the edge detection region can be adjusted in experiments to obtain good edge detection results. When a rotating fan blade passed the edge detection region, the tracking CSLDV system started to track the rotating fan blade and scan a straight scan path on it. If a rotating fan blade that is not the one that should be scanned passed the edge detection region, one can shift the scan path to the rotating fan blade that should be scanned by using Eq. (24).

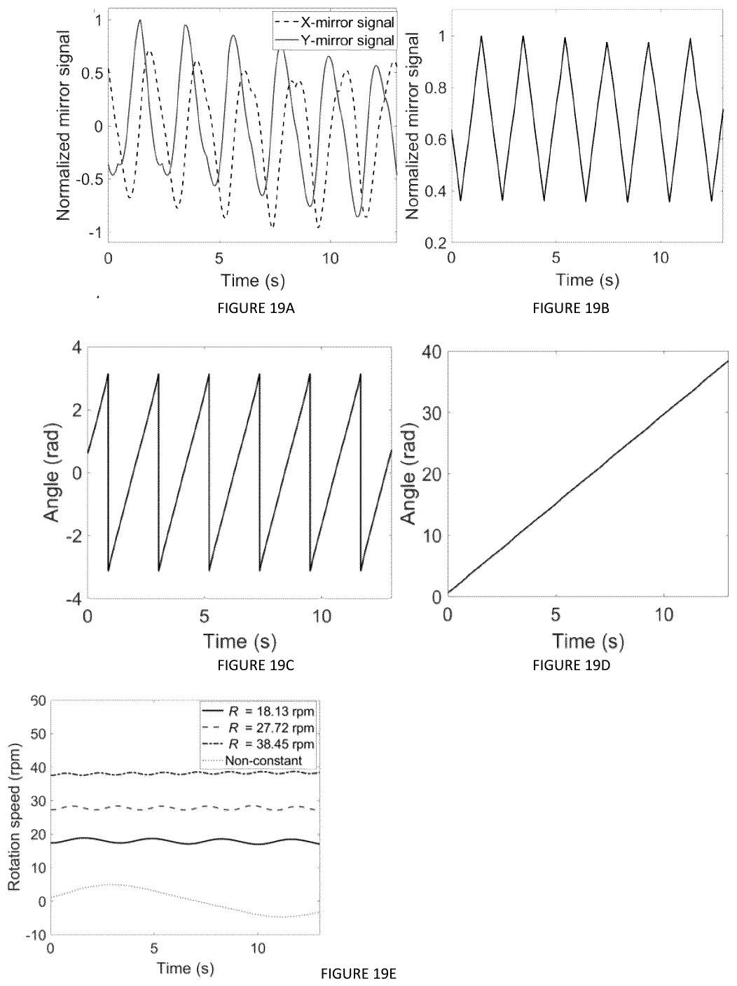

Mirror signals of the tracking CSLDV system when scanning the rotating fan blade with R=27.72 rpm are shown in FIG. 19A. The processed mirror signal obtained by Eq. (27) is shown in FIG. 19B. Note that mirror signals in FIGS. 19A and 19B were normalized by dividing them with their respective maximum values. The polar angle of the laser spot in the polar coordinate system whose pole is at the hub center and whose polar axis is along the X direction was calculated from mirror signals of the tracking CSLDV system by using Eq. (28) (FIG. 19C). When transforming the position of the laser spot in the O-XY coordinate system to the position in the polar coordinate system, the range of the polar angle is from −π to π and the angle in FIG. 19C is hence not continuous. To obtain the continuous rotation speed of the fan blade, the angle was processed to be continuous in FIG. 19D, which is close to a straight line since the fan blades rotated with a constant speed. The derivative of the continuous angle in FIG. 19D was calculated and the rotation speed of the fan blade can be obtained by Eq. (29). Estimated rotation speeds of the fan blade with different constant speeds and a non-constant speed are shown in FIG. 19E. Estimated constant rotation speeds of the fan blade were basically constant, but slightly vary with time, which can be caused by unbalance of blades of the rotating fan due to different weights of the blades.

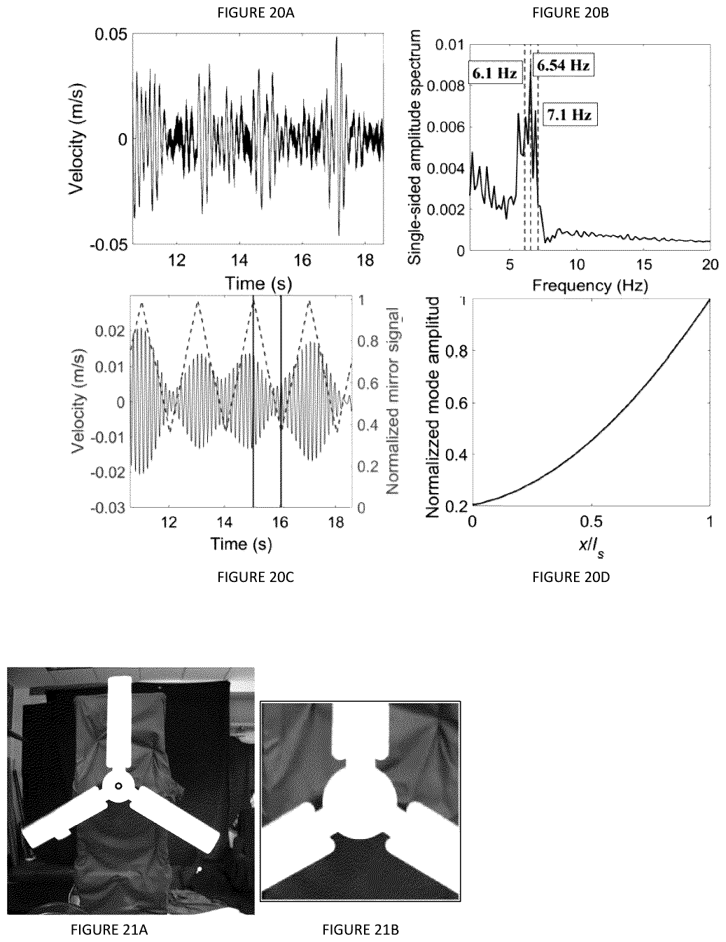

The measured response of the tracking CSLDV system when R=27.72 rpm is shown in FIG. 20A. The processing procedure for estimating the first undamped mode shapes of the rotating fan blade is shown as an example below. The FFT of the measured response is shown in FIG. 20B. The estimated first damped natural frequency of the rotating fan blade when R=27.72 rpm is 6.54 Hz, which is shown as a dashed line in FIG. 20B. Note that the other peak near the one at 6.54 Hz in FIG. 20B is the damped natural frequency of one of the other two blades. One can use the small fan to excite only one blade of the stationary fan and check the FFT of a measured response to see which peak in the FFT corresponds to the fan blade that is being tracked and scanned. A band-pass filter whose passband is from 6.1 to 7.1 Hz is shown as two dashed lines in FIG. 20B. The band-pass filter is applied to the measured response in FIG. 20A, and the resulting filtered response is shown in FIG. 20C where a zigzag line denotes the corresponding processed mirror signal. Two straight vertical lines in FIG. 20C show time instants when the laser spot arrives at two ends of the scan path, and the measured response in the time interval between the two time instants can be used to obtain undamped mode shapes of the rotating fan blade. The filtered measured response is multiplied by a sinusoid whose frequency is the damped natural frequency estimated in FIG. 20B, and the first normalized undamped mode shape of the rotating fan blade when R=27.72 rpm is extracted from the processed filtered measured response that is in the time interval (FIG. 20D). Note that Is in FIG. 20D is the length of the scan path, and normalized undamped mode shapes of the rotating fan blade are obtained by dividing them with their respective maximum values. The normalized mode amplitude at

$$\frac{x}{{l}_{s}} = 0$$

was not zero in FIG. 20D since the end of the scan path that was near the fan hub was not exactly fixed and there could be some vibration there when the fan blades rotated.

In some embodiments, the improved demodulation method was used to obtain damped natural frequencies and undamped mode shapes of the rotating fan blade with different constant speeds and a non-constant speed. Note that the time interval that was used to estimate undamped mode shapes in FIG. 20C was only 1 sec so that the rotation speed of the fan blade could be considered as a constant and therefore estimated mode shapes of the rotating fan blade with a non-constant speed could be considered as its instantaneous undamped mode shapes in short time intervals. Estimated damped natural frequencies of the rotating fan blade with different constant speeds are shown in Table 4. Damped natural frequencies of the rotating fan blade increase with its rotation speed (Table 4), which is caused by the centrifugal stiffening effect due to its rotation.

TABLE 4
Estimated damped natural frequencies of the rotating
fan blade with different constant speeds

| Rotation speed | 18.13 rpm | 27.72 rpm | 38.45 rpm |
|---|---|---|---|
| First damped natural | 6.20 | 6.54 | 6.90 |
| frequency (Hz) | | | |
| Second damped | 28.67 | 28.83 | 29.07 |
| natural frequency (Hz) | | | |
| Second damped | 56.31 | 57.17 | 57.60 |
| natural frequency (Hz) | | | |

The first three undamped mode shapes of the rotating fan blade were measured with different constant speeds and a non-constant speed (not shown). Undamped mode shapes of the rotating fan blade were similar to those of a cantilever beam since the rotating fan blade can be considered as a rotating cantilever beam. Estimated undamped mode shapes have some differences from each other because they were estimated with different rotation speeds and scan paths when tracking the rotating fan blade with different speeds can be somewhat different. Note that a rotating horizontal-axis wind turbine blade can have torsional and edgewise mode shapes [48-50], which cannot be estimated using the 1D scan scheme.

Although, not used in this example, it should be appreciated by the person skilled in the art that an improved lifting method can be used to obtain the desired modal parameters.

### Conclusions

An edge detection method for an image-based tracking CSLV system, e.g., a tracking CSLDV system, is described herein, wherein the method tracks and scans a rotating structure using a 1D scan scheme. The edge detection method can detect points on an edge of the rotating structure and track the edge without attaching any encoder or mark to the structure. A 1D scan scheme was used to generate straight scan paths on the rotating structure based on positions of edge points detected by the edge detection method. Mirror signals of the tracking CSLV system can be processed to extract undamped mode shapes from measured response of the tracking CSLV system and estimate rotation speeds of the rotating structure. An improved demodulation method was used to process measured responses of the tracking CSLDV system, although it should be appreciated by the person skilled in the art that an improved lifting method can be used to process measured responses of the tracking CSLDV system. The first three damped natural frequencies and undamped mode shapes of the rotating fan blade with different constant speeds and the first three instantaneous undamped mode shapes with a non-constant speed were successfully estimated. The image-based tracking CSLV system can be used to track and scan large horizontal-axis wind turbine blades and monitor their vibrations and velocities.

### Example 3—Using Edge Detection to Estimate Real-Time Angular Positions and Angular Velocities of RS

The reliability of many systems depends on internal rotating mechanisms. Angular positions and angular velocities are fundamental characteristics of these mechanisms, which are vital for calculating, analyzing, and predicting the systems' dynamic performance. These characteristics are traditionally measured using hardware that are included in the system's design, such as a speedometer in an automobile. Similar sensor-based methods employ electromechanical sensors such as accelerometers, tachometers, and GPS tracking sensors, which are fixed to the systems in some fashion, for estimating the instantaneous angular position and velocity of a rotating component.

Sensor installation onto an operational system that does not have a sensor built-in can be a laborious, high-cost process depending on the desired sensor position. Due to the demanding consequences of sensor placement and maintenance, non-contact, computer vision-based measurement methods are particularly promising. Operational modal analysis, operational deflection shape measurement, damage detection, and vibration response monitoring are examples of measurement techniques where vision-based measurement methods have made considerable impact. Researchers in these areas have resorted to computer vision-based applications that replace hardware-based sensors to achieve non-contact measurements.

A non-contact method of using edge detection to measure angular positions and velocities of a RS using a monocular camera system is described in this example. This method can be used in a low-cost, robust vision-based measurement method for rotating structures, e.g., wind turbine blades, that is easily deployed, bounded by minimal constraints, and does not require high computational power. In some embodiments, the rotation center and a region around it are static and stable. In some embodiments, the rotation center is visible to the camera with no occlusions. In some embodiments, the center hub and portions of the blades close to the center hub have a nearly homogeneous color, a smooth profile, and a continuous geometry. In some embodiments, the turbine blades are one of the largest moving objects or the only moving objects in the frame.

### A Review of Digital Images and Sobel Edge Detection

A digital image is a 2D array of pixels that are specified by row and column indices [i, j]. In colored images, the color of each pixel is governed by a combination of red, green, and blue light intensities, but these images contain a large amount of data that is unnecessary for many image processing tasks. The data contained in an image is reduced by converting the colored image into a gray-scale image where the color of each pixel is governed by a range of values from 0 (black) to 255 (white) with shades of gray between the two limits. Edges constitute areas of sharp, local pixel intensity changes in an image. Detecting these regions is the goal of edge detection methods. When an image is subjected to edge detection, the result is an image that primarily consists of detected edges, which is called an edge map.

When an object occupies a significant portion of the frame and has pixel intensities that are sufficiently different from pixel intensities in the background, the image histogram displays a bimodal distribution of pixel intensities. Separating an object from the background is accomplished by separating the two peaks in the histogram. Thresholding is a fundamental technique of image segmentation used to locate boundaries of objects in an image by using a threshold value to filter pixel intensities. Consider a point in the edge map of an image that has a gray-scale intensity of I_{f} where 0<I_{f}<255. A threshold value T is used to determine if the pixel should remain in or be removed from the frame. I_{f} I_{f}<T, then I_{f}→0. On the other hand, I_{f} remains in the frame if I_{f}≥ T. Thresholding can be used to filter a gray-scale image that contains small areas of discontinuous pixel intensities, or it can be used to convert an image into a binary image.

Binary images reveal edges within an image. In some embodiments, basic edge detection is used due to the computational simplicity and ease of implantation. Sobel edge detection is a first-order, gradient magnitude-based algorithm that convolves an image with two 3×3 kernels. The Sobel kernels have smoothing characteristics and are defined as

$${M}_{x} = [ \begin{matrix}- 1 & - 2 & - 1 \\ 0 & 0 & 0 \\ 1 & 2 & 1\end{matrix} ] {M}_{y} = [ \begin{matrix}- 1 & 0 & 1 \\ - 2 & 0 & 2 \\ - 1 & 0 & 1\end{matrix} ] \qquad ( 30 )$$

When an image undergoes convolution with the Sobel kernels, Mₓ produces an edge map with horizontal gradients and M_{y} produces an edge map with vertical gradients. An image f will have a gradient ∇f at arbitrary coordinates (x,y) defined as a 2D column vector

$$∇ f = [ \begin{matrix}{g}_{x} \\ {g}_{y}\end{matrix} ] \qquad ( 31 )$$

where gₓ is the difference between the third and first rows of Mₓ and g_{y} is the difference between the third and first columns of M_{y}. The magnitude of the gradient ∇f is the vector norm defined as

$$M ( x , y ) = ‖ ∇ f ‖ = \sqrt{{g}_{x}^{2} + {g}_{y}^{2}} \qquad ( 32 )$$

The positions in the image where the gradient magnitude is the largest is found by global thresholding, which applies one or multiple static threshold values over the entire image.

### Methodology and Experimental Setup

To simulate a small-scale replica of a horizontal-axis wind turbine, a 56-inch Westinghouse, three-bladed ceiling fan was vertically mounted on an aluminum frame with its rotation axis pointed at a camera, which is positioned 1.7 m away from the fan. While the area behind the frame was shrouded in a black cloth to represent a homogeneous colored background, which was beneficial for edge detection and other image processing techniques, it was not necessary. An algorithm was designed using the system engineering software LabVIEW from National Instruments. The controller model was NI 9149 and images were captured by a Basler Camera that had a maximum frame rate of 90 frames per second with a 4 MP (2048×2048 pixels) resolution. The camera lens was equipped with a manually adjustable aperture that could reduce or increase the amount of light that the camera sensor detected. In some embodiments, the camera used can capture images with a large aperture setting.

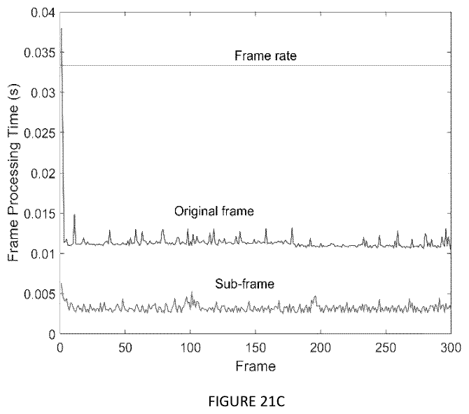

The 720×720 frame shown in FIG. 21A is a reduced frame from the 2048×2048 frame captured by the camera. Even though the frame is reduced, it is clear that a significant portion of the frame is unnecessary for obtaining information about the fan's rotation. In some embodiments, reducing the size of the processing region is beneficial for reducing the amount of processing time. Edge detection is a spatial domain process that uses local pixel neighborhoods to estimate local gradients in pixel intensities, therefore a frame with fewer pixels requires less time to process. FIG. 21B shows a 350×350 sub-frame that was obtained from the 720×720 frame. The graph in FIG. 21C shows the impact of reducing the frame size on processing time when Sobel edge detection was applied to both frames. The graph contains a horizontal line that depicts the frame rate of the camera (30 frames per second). Processing the first 720×720 original frame takes longer time than to receive the next frame. Processing each sub-frame is on average 30.9% faster than processing the original frame, and the first sub-frame was processed faster than the frame rate of the camera. Since the processing time must be faster than the frame rate of the camera for real-time performance, sub-frame analysis is preferred. The processing time will decrease as the sub-frame becomes smaller. However, there is a minimum size that the sub-frame can be for each blade to remain visible, as readily determined by the person skilled in the art. The mark in the middle of FIG. 21A indicates the position of the rotation center, which is instrumental for functionality of the proposed algorithm.

The method described herein utilizes automatic detection of the rotation center and sub-frame generation. Assuming that the fan is the largest moving object in the video and both the camera and fan are static, the center hub experiences no translation between frames. When the center hub has a relatively homogeneous color, the pixel intensities in a sequence of frames will remain nearly constant. Regions of constant intensity facilitate effective background subtraction results. Therefore, a cumulative sum of multiple differential frames results in a circular region that outlines the rotation center. Notably, the cumulative differential frame was unnecessary in the controlled environment of the proof of concept experiment, however, it was included because in outdoor environments there were many factors that will affect the detection of wind turbine blades relative to the background. Anomalies such as clouds, the time of day, and shadows could degrade the performance of the proposed algorithm.

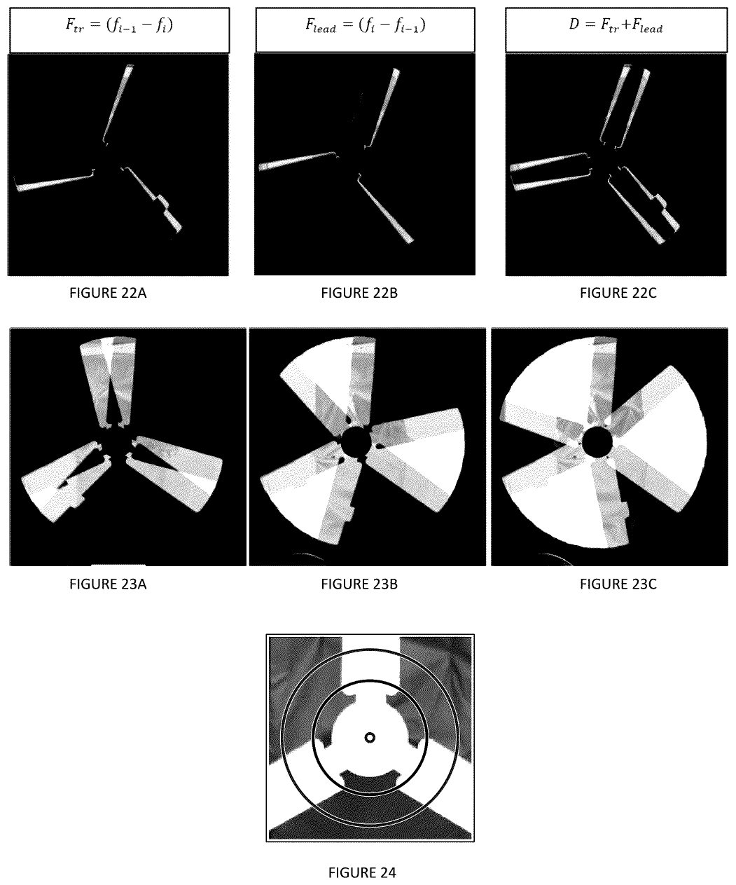

Consider two consecutive frames acquired from a video sequence. Let the current frame be denoted as fᵢ, and the previous frame as fᵢ₋₁. Depending on the ordering of the two frames, the angular displacement between either side of a blade can be revealed. A rotating blade has a leading and trailing edge. The fan used in the experimental setup rotates counterclockwise. Therefore, let the differential frame containing the trailing edge be denoted as Fₜᵣ and the differential frame containing the leading edge as F_{lead}, as shown in FIGS. 22A and 22B, respectively. The sum of the two separate differential frames shows the angular displacement of both sides of each blade, denoted as the total differential frame, as shown in FIG. 22C. The total differential frame in FIG. 22C was formed using two consecutive frames, but it is apparent that the two frames alone do not provide sufficient information about the rotation center. When a sequence of consecutive frames is used, a cumulative differential frame D_{N} can be constructed. If two frames are the minimum number of frames needed to generate any meaningful data about the fan, then a cumulative differential frame is given by

$${D}_{N} = {\sum }_{i = 2}^{N} [ ( {f}_{i} - {f}_{i - 1} ) + ( {f}_{i - 1} - {f}_{i} ) ] \qquad ( 33 )$$

FIGS. 23A-23C depict the differential frames formed using 5, 10, and 15 frames, respectively. It is apparent that the more frames used, the more visible the rotation center becomes.

Once a suitable differential frame is made, the rotation center can be found using a circular Hough transform. For the method of this example, the built-in function within the MATLAB Image Processing Toolbox was used. The Hough transform returns a fixed position for the rotation center located at (x_{c}, y_{c}). These coordinates are used to form the dimensions of a sub-frame. Two transformation constants dₓ and d_{y} are chosen to be equal so that the sub-frame is a square, although other sub-frame shapes can be used as readily determined by the person skilled in the art. Within the sub-frame, an annular region around the rotation center is used to determine the locations of individual blades at any given time. FIG. 24 illustrates that two circles centered at the rotation center form an annulus, comprised of an inner radius rᵢ and an outer radius rₒ. For any wind turbine, the area of rotation where the blades can be positioned is circular with a maximum radius that is equal to the length of the blades, and the rotation center forms a circular region, which would be the minimum radius. If the maximum radius of the blades is denoted as rₘₐₓ and the minimum radius of the rotation center r_{c}, then the radii of the annulus are chosen so that

$${r}_{c} < {r}_{i} < {r}_{o} < {r}_{max} \qquad ( 34 )$$

The distance between the rotation center and any edge in the frame at (xₑ, Yₑ) is given by

$${d}_{c \vert e} = \sqrt{{( {x}_{c} - {x}_{e} )}^{2} + {( {y}_{c} - {y}_{e} )}^{2}} \qquad ( 35 )$$

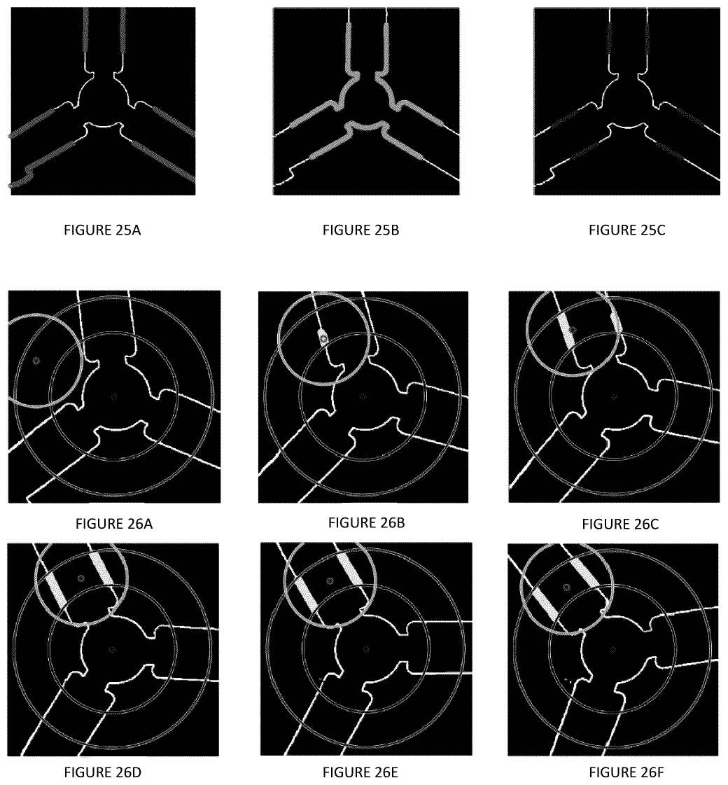

Let A be the set whose elements are the coordinates of every edge in the frame. Let B be the set whose elements are those with distances greater than rᵢ, i.e., d_{c|e}>rᵢ, and let C be the set whose elements are the edges with distances less than rₒ, d_{c|e}<rₒ. The sets B and C are shown in FIGS. 25A and 25B, respectively. The edges that reside within the radial bounds are the elements of the intersection of the sets A and B. The set G=B∩C will contain the edges that reside between the two radii.

The localized edges shown in FIG. 25C are those that are desired for detection. Since these points are constrained to the coordinates encompassed by the radial bounds, a virtual reference point can be used to detect any blade that approaches it. Consider a reference point with coordinates (xᵣ, yᵣ) so that

$${r}_{c} < {r}_{i} < {d}_{c \vert r} < {r}_{o} < {r}_{max} \qquad ( 36 )$$

$$where$$

$${d}_{c \vert r} = \sqrt{{( {x}_{c} - {x}_{r} )}^{2} + {( {y}_{c} - {y}_{r} )}^{2}} \qquad ( 37 )$$

A neighboring distance dₙ is used to define a circular area around the reference position whose coordinates can be used to detect when edges are close to the reference position. The distance between the reference position and any edge within the radial bounds is given by

$${d}_{r \vert e} = \sqrt{{( {x}_{r} - {x}_{e} )}^{2} + {( {y}_{r} - {y}_{e} )}^{2}} \qquad ( 38 )$$

An edge located within the neighboring distance around the reference position will satisfy the condition

$${d}_{r \vert e} < {d}_{n} \qquad ( 39 )$$

Let H be the set whose elements reside within the neighboring distance around the reference position; then a set E that contains the edges closest to the reference position is given by

$$E = H ⋂ G \qquad ( 40 )$$

The random nature of detected edges between frames is suppressed by using the average location of all edges in the set E. FIG. 26A illustrates that a reference position between the radial bounds is initially distant from any edges of the blades. When edges enter the region around the reference position, the average location of the edges is calculated, which forces the reference position to become the average position of all edges around it, as shown in FIG. 26B. As more edges are found around the reference position, the coalescence of additional edges causes the reference position to occupy a position near the center of the blade that is detected, which can be seen in FIGS. 26C and 26D. As more edges are detected around the reference position, the average location continues to shift towards the middle of the blade and eventually becomes balanced within it. FIGS. 26D-26F show that the reference position continues to occupy a position in the middle of the blade as it continues to rotate.

The initial angle between the reference position and rotation center is calculated using the four-quadrant atan 2 function defined as

$${θ}_{r} = a tan 2 ( {y}_{c} - {y}_{r} , {x}_{c} - {x}_{r} ) \qquad ( 41 )$$

with −π≤θᵣ≤π. The direction of rotation of the fan determines if the change in angle between two consecutive frames will be positive or negative. When edges approach the reference position, the angular position of the reference position will either jump to an edge that approaches it or jump to an edge that moves away from it. This depends on the positions of the blades when the proposed algorithm is initiated. Consider two consecutive frames of a video sequence. Let the angle of the reference position in the current frame be θᵣⁱ, and the angle of the reference position in the previous frame θᵣⁱ⁻¹. Since the differential-frame approach is used, i>2. The change in angle between the two frames is then given by

$$Δ {θ}_{r} = {θ}_{r}^{i} - {θ}_{r}^{i - 1} \qquad ( 42 )$$

The amount of time to process the frame Δt can be used to calculate the angular velocity in radians per second, which can then be converted to rotations per minute. Thus, the angular velocity in rotations per minute is given by

$$RPM = \frac{Δ {θ}_{r}}{Δ t} \cdot \frac{60}{2 π} \qquad ( 43 )$$

### Laboratory Experiment

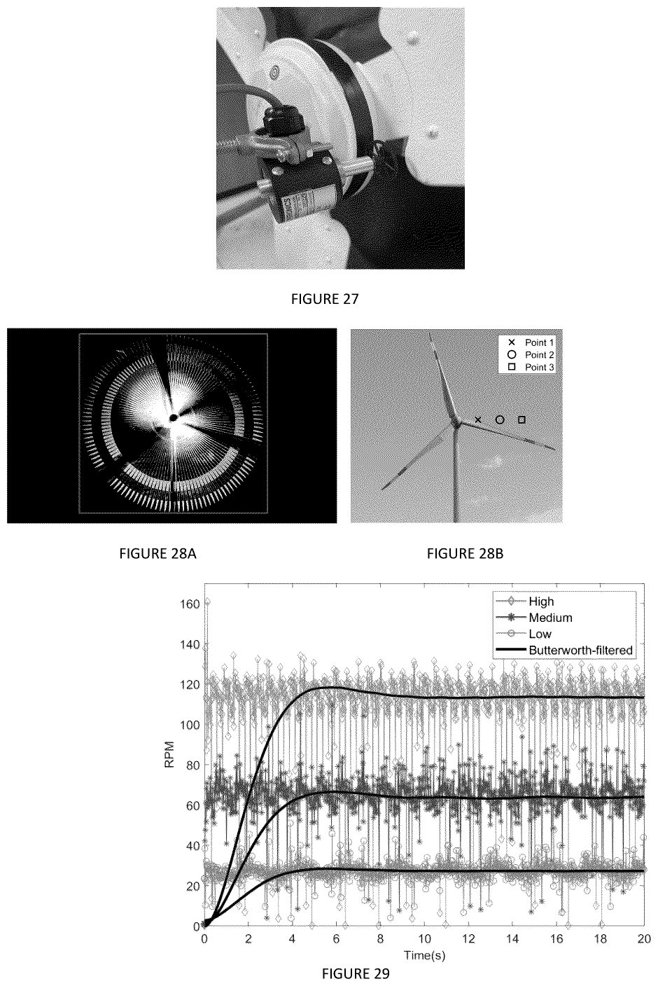

A proof of concept experiment was carried out by using the proposed algorithm to measure the angular velocity of the fan's high-, medium-, and low-speed settings. Measurements were taken while the angular velocity of the fan was constant. The camera's frame rate was set at 50 frames per second, and multiple sets of data were gathered in 20-second intervals. After the data for one angular velocity was collected, data acquisition was stopped while the fan accelerated to the next velocity. Data obtained from the edge detection method was compared to angular velocities measured by a hollow-shaft rotary encoder. The fan did not have an external shaft to attach an encoder to so the perimeter of the fan was wrapped with a two-sided adhesive tape that acted as a track for a wheel to roll on. A wheel was secured to an encoder that could be rotated to contact the side of the fan, as shown in FIG. 27. When the wheel contacted the tape, the wheel first accelerated to match the angular velocity of the fan. After reaching the speed of the fan, the fan began decelerating due to the friction between the wheel and tape; so meaningful data was only present within the first few data points. A sampling rate of 50 Hz was used to acquire the encoder readings, and 20 data sets were collected for each fan speed. The first 50 data points of each set were combined into a 1000-point data set for each fan velocity.

For the simulated tests, two videos of wind turbines were used, and each video was captured from a stationary camera. The first video depicted a wind turbine in full view that was isolated in the frame. The second video depicted multiple wind turbines with various objects in the frame. The method for automatic rotation center detection was applied to each video. Once the coordinates of the rotation centers were obtained, a random frame within the first two seconds of each video was used to initiate the algorithm. This was done because in a real-world situation, the turbine blades would not be in the same position as they were when the rotation center was obtained. As stated before, the parameters used to obtain the best results of blade positioning are environment specific. To find the appropriate parameters, three different reference points were used with different distances to the rotation center. The parameters consisted of the binary threshold, neighboring distance, and distance from each rotation center. The algorithm was initiated with each point and a starting threshold of 0.01. After each algorithmic operation, the threshold was increased by 0.01 to 0.04. Once the data from each threshold was obtained, the next point was used to initiate the algorithm, and the procedure was repeated. The optimal parameters for each video are those that produced the highest signal-to-noise ratio in the coordinates of the blades. FIG. 28A shows the cumulative differential frame of a turbine of interest from the first video overlayed with a rectangle that illustrates the sub-frame relative to the initial frame. FIG. 28B shows the sub-frame with test points indicated. Table 5 contains the parameters used to develop the cumulative differential frames and detect the rotation centers, the coordinates of the rotation centers in the original frames and sub-frames, the transformation constants of the sub-frames, and the coordinates of the three test points in each video.

TABLE 5
Parameters used to detect the rotation centers in the test videos

| Center Detection Parameters | Video 1 | Video 2 (A) | Video 2 (B) |
|---|---|---|---|
| Cumulative Frame Number (N) | 40 | 35 | 70 |
| Preprocessing Threshold | 100 | 175 | 165 |
| Circular Hough Transform Radius | [5, 30] | [5, 30] | [3, 15] |
| Range | | | |
| Center Coordinates (Original Frame) | (646, 332) | (686, 219) | (829, 417) |
| Center Coordinates (Sub-frame) | (365.5, 330.5) | (175.5, 175.5) | (90.5, 90.5) |
| Transformation Constants (dₓ, d_{y}) | (365, 330.5) | (175, 175) | (90, 90) |
| Point 1 Coordinates | (440.5, 330.5) | (225.5, 175.5) | (120, 90.5) |
| Point 2 Coordinates | (515.5, 330.5) | (260.5, 175.5) | (140, 90.5) |
| Point 3 Coordinates | (590.5, 330.5) | (295.5, 175.5) | (160, 90.5) |

### Laboratory Experimental Results

The angular velocities obtained from the proposed algorithm were populated with of high frequency noise, as seen in FIG. 29. Real-time filtering is performed by incorporating a point-to-point, second-order low-pass Butterworth filter with a sampling frequency of 50 Hz. The low and high cutoff frequencies used in this work were LabVIEW default values of 0.125 Hz and 0.45 Hz, respectively. These values were selected based on the criteria specified in Ref. [11] so that 0<f₁<f₂<0.5fₛ, where f₁ is the low cutoff frequency, f₂ is the high cutoff frequency, and fₛ is the sampling frequency.

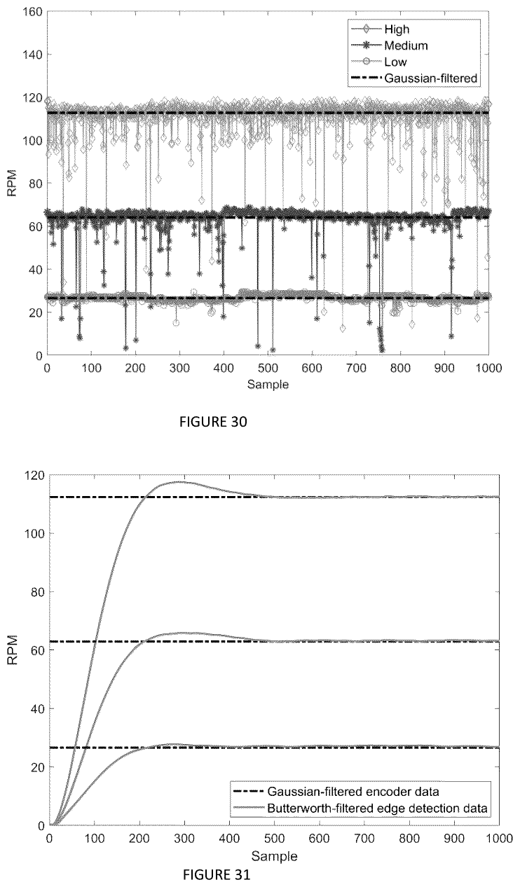

The encoder data was smoothed using a 1D Gaussian weighted moving-average filter with a window size of 2000 for each angular velocity. Smoothing the encoder data was necessary to remove any data that resulted from slip between the wheel and tape. Slipping did not add significant noise during low angular velocity measurements, but added a high level of noise when measuring the medium and high angular velocities (FIG. 30). Table 6 shows average values of the filtered edge detection and smoothed encoder data for each angular velocity of the fan.

TABLE 6
Averages of filtered angular velocities for each fan
speed from the edge detection and encoder methods

| | | | |
|---|---|---|---|
| Edge Detection | High | 112.82 | RPM |
| | Medium | 63.37 | RPM |
| | Low | 26.14 | RPM |
| Rotary Encoder | High | 112.61 | RPM |
| | Medium | 64.10 | RPM |
| | Low | 26.49 | RPM |

The percent differences of angular velocities obtained from the proposed algorithm and encoder method were used to analyze their similarities. FIG. 31 shows a comparison between the Butterworth-filtered edge detection velocities and the Gaussian-filtered velocities obtained from the encoder. Filtering the angular velocities in real time shows a profile that resembles an under-damped response because the initial reference position was stationary. The overshoot of each profile decreases before nearly converging to a constant angular velocity. Table 7 lists the average percent differences between the angular velocities from the edge detection and encoder methods after the overshoot.

TABLE 7
Average percent differences between the angular velocities
from the edge detection and encoder methods

| | |
|---|---|
| High | 0.298% |
| Medium | 0.546% |
| Low | 1.369% |

### Simulated Experimental Results

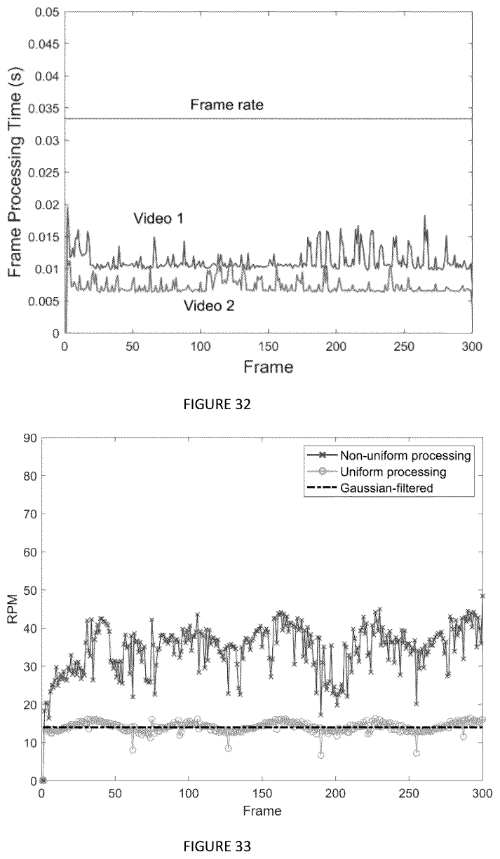

To mimic real-time image acquisition, the objective of the simulated experimental results was to process the frames of each video and calculate the angular velocities faster than the video frame rates. Using the sub-frame dimensions from the videos, the processing times for the frames of each video was determined, as shown in FIG. 32, with a horizontal line representing the frame rate of the cameras since both videos were captured at same frame rate. Since the durations of the videos are different, each video was processed for 10 seconds. Both videos had each of their frames processed faster than their frame rates. When video sequences are processed in real time, the algorithm must wait for the camera to produce the next frame. Frames from each video can be quickly processed relative to the rate at which they arrive. While FIG. 32 illustrates that video frames are processed significantly faster than the video frame rates, the processing times are not constant. This translates to a nonuniform processing rate and the timesteps used to calculate the angular velocity in the current frame will be different from that of the previous frame. Non-uniform processing rates significantly skew the angular velocity calculations by contributing high noise levels in the angular displacement measurements. To more closely mimic real-time frame acquisition, a process timing condition was imposed. Let Δt be the frame processing time and t_{c} the frame rate of the camera, wherein Δt=t_{c} when Δt<t_{c}. This timing constraint forces the processing time to be uniform for the duration of the available frames. FIG. 33 illustrates a reduction of noise in the angular velocity calculations and a reduction in the angular velocities when uniform processing times are enforced. The larger spikes in both sets of constrained and unconstrained angular velocities are caused by shadows and variations of light reflecting off the blades. However, these spikes are outliers compared to the other data and can therefore be considered high-frequency noise. The angular velocities are still noisy and have an oscillating behavior after enforcing timing constraints. Since the angular velocities of interest were nearly constant, a 1D Gaussian weighted moving-average filter with a window size of 2000 was used to smooth the angular velocities obtained from the videos, which are shown as the horizontal lines in FIG. 33. Table 8 lists the estimated angular velocities for each video.

TABLE 8
Estimated angular velocities of the turbines from the test videos

| | |
|---|---|
| Video 1 | 13.7 RPM |
| Video 2 (Turbine A) | 15.9 RPM |
| Video 2 (Turbine B) | 16.5 RPM |

### Discussion

The Butterworth-filtered edge detection data in FIG. 31 overshot the angular velocities from the encoder method before converging to a constant velocity. Measurement differences tended to decrease with increasing constant fan velocities, which may be explained by a piece of tape attached to the surface of one fan blade. When the fan rotated at its lowest angular velocity, the additional mass of the tape caused a loss of angular momentum of the fan. This additional mass caused the fan to rotate slightly faster and slower each time the tape-covered blade approached and traveled past the maximum vertical position along its rotation path, respectively. Slight variations of the fan's angular velocity can be seen in the unfiltered angular velocity measurements from the edge detection method (FIG. 29). As the angular velocity increased, the effect of this imbalance is reduced.

As previously stated, the actual angular velocities of the fan did not agree with the specifications supplied by the manufacturer; however, the results in Table 6 agreed with visual observations. The differences between the angular velocities obtained from the proposed algorithm and rotary encoder in Table 7 remain under 2%; the real-time angular velocities from the proposed algorithm were validated by the encoder method.

The processing times of the first video in the simulated experiment were higher than those of the second most likely because the camera was positioned closer to the turbine in the first video. The closer the camera to the turbine, the large the sub-frame and therefore the larger the processing area. Turbines A and B in the second video required the use of different parameters to form the cumulative differential frames, which was necessary because the orientations of the turbines with respect to the camera and their distances from the camera were different. Note that the size of the neighboring distance dₙ that was used for detecting edges around the reference point depended on the distance of a turbine from the camera. The actual angular velocities of the turbine blades in each test video were unknown. According to the Office of Energy Efficiency and Renewable Energy, the rotor blades of a land-based gearbox turbine rotate between 8-20 rotations per minute, depending on the ambient wind speed. Therefore, the estimated angular velocities in Table 8 appear to be accurate estimations of the angular velocities. Therefore, the proposed algorithm has promising potential for use in real-world environments.

### Conclusions

The method of this example presents a true non-contact method for estimating the angular positions and velocities of a rotating structure using edge detection. By applying suitable thresholds and extracting a region of interest around the rotation center, it is possible to track the angular position of the rotating structure and accurately estimate its angular velocity while maintaining zero contact. In some embodiments, the method is performed without attaching an encoder or mark to the rotating structure. Real-time angular velocities from the proposed algorithm were validated by the angular velocities obtained from a rotary encoder. Real-world simulations show that the proposed algorithm has promising potential due to adjustable radial bounds, automatic rotation center detection, and environment-specific tunable image processing parameters. Simulating the performance of the algorithm in various environments shows the versatility of this approach. There are potential applications for this method to be used in vibration response measurement and structural health monitoring of large-scale rotating structures such as rotating blades of horizontal-axis wind turbines and helicopters.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

### REFERENCES

[1] K. Kishinami, H. Taniguchi, J. Suzuki, H. Ibano, T. Kazunou, and M. Turuhami, Theoretical and experimental study on the aerodynamic characteristics of a horizontal axis wind turbine, Energy, 30(11-12) (2005), pp. 2089-2100.
[2] R. Jain, R. Kasturi, and B. G. Schunck, Machine vision. McGraw-hill, New York, 1995.
[3] R. Jayakumar, and B. Suresh, A review on edge detection methods and techniques. International Journal of Advanced Research in Computer and Communication Engineering, 3(4) (2014), pp. 6369-6371.
[4] S. Savant, A review on edge detection techniques for image segmentation. International Journal of Computer Science and Information Technologies, 5(4) (2014), pp. 5898-5900.
[5] J. R. Bell, and S. J. Rothberg, Laser vibrometers and contacting transducers, target rotation and six degree-of-freedom vibration: what do we really measure? Journal of Sound and Vibration, 237 (2000), pp. 245-261.
[6] S. Rothberg, M. Allen, and P. Castellini, An international review of laser Doppler vibrometry: making light work of vibration measurement, Optics and Lasers in Engineering. 99(1) (2017), pp. 11-22.
[7] L. F. Lyu, G. D. Higgins, and W. D. Zhu, Operational modal analysis of a rotating structure using image-based tracking continuously scanning laser Doppler vibrometry via a novel edge detection method, Journal of Sound and Vibration, 525 (2022), 116797.
[8] L. F., Lyu, and W. D. Zhu, Operational modal analysis of a rotating structure under ambient excitation using a tracking continuously scanning laser Doppler vibrometer system, Mechanical Systems and Signal Processing, 152 (2021), 107367.
[9] L. F., Lyu, and W. D. Zhu, Operational modal analysis of a rotating structure subject to random excitation using a tracking continuously scanning laser Doppler vibrometer via an improved demodulation method, Journal of Vibration and Acoustics, 144(1) (2021), 011006.
[10] L. F. Lyu, and W. D. Zhu, Full-field mode shape estimation of a rotating structure subject to random excitation using a tracking continuously scanning laser Doppler vibrometer via a two-dimensional scan scheme, Mechanical Systems and Signal Processing, 169 (2022), 108532.
[11] National Instruments. Signal Processing Toolset User Manual. National Instruments Corporation, Texas, 2001.

1. A method of detecting and identifying edges of a rotating structure (RS) for an image-based tracking system, the method comprising:
determining real-time positions of points on edges of the RS by processing images captured by the image-based tracking system; and
using the image-based tracking system to scan at least a portion of a surface of the RS using a one-dimensional (1D) or two-dimensional (2D) scan scheme,
wherein the method is performed without attaching any mark or encoder to the RS.

2.-3. (canceled)

4. The method of claim 1, wherein the image-based tracking system is a tracking continuously scanning laser vibrometer (CSLV) system.

5.-18. (canceled)

19. A method of estimating a rotation speed of a blade of a rotating structure, said method comprising the method of detecting and identifying edges of a rotating structure (RS) for an image-based tracking system of claim 1.

20. A method for estimating angular positions and/or angular velocities of a rotating structure (RS) using edge detection, the method comprising:
detecting edges of the RS by tracking a location of an identified point;
transforming the location of the identified point into polar coordinates to determine angular positions; and
using the angular positions to calculate real-time angular velocities,
wherein the method is performed without attaching any mark or encoder to the RS.

21. The method of claim 20, wherein the method is a zero-contact method.

22. The method of claim 20, wherein the method utilizes a monocular camera system.

23. The method of claim 20, wherein the location of the identified point is determined by:
reducing the size of an image processing region to generate a sub-frame;
detecting a rotation center of the RS;
generating an annular region around the rotation center; and
using a virtual reference point to detect a plurality of single identified points on the edge of the RS within the annular region, wherein when the edges enter the region around the virtual reference position, the average location of the edges is calculated.

24. The method of claim 23, wherein the detection of the rotation center comprises constructing a cumulative differential frame from a sequence of consecutive frames.

25. The method of claim 20, wherein the identified point is a single identified point.

26. The method of claim 20, wherein the identified point is an average of the plurality of single identified points.

27. The method of claim 20, wherein the RS is a wind turbine blade.

28. The method of claim 23, wherein the image processing region includes the RS.

29. The method of claim 23, comprising at least one of the following conditions: (a) the rotation center and a region around it are static and stable; (b) the rotation center is visible to a camera with substantially no occlusions; (c) a center hub of the RS and portions of the blades close to the center hub have a substantially homogeneous color, a substantially smooth profile, and a substantially continuous geometry; and (d) the blades of the RS are one of the largest moving objects or the only moving objects in the image processing region.

30. A method of detecting and identifying edges of a rotating structure (RS), the method comprising:
reducing the size of an image processing region to generate a sub-frame;
detecting a rotation center of the RS;
generating an annular region around the rotation center; and
using a virtual reference point to detect a plurality of single identified points on the edge of the RS within the annular region, wherein when the edges enter the region around the virtual reference position, the average location of the edges is calculated.

31. The method of claim 30, wherein the detection of the rotation center comprises constructing a cumulative differential frame from a sequence of consecutive frames.

32. The method of claim 30, wherein the identified point is a single identified point.

33. The method of claim 30, wherein the identified point is an average of the plurality of single identified points.

34. The method of claim 30, wherein the RS is a wind turbine blade.

35. The method of claim 30, wherein the image processing region includes the RS.

36. The method of claim 30, comprising at least one of the following conditions: (a) the rotation center and a region around it are static and stable; (b) the rotation center is visible to a camera with substantially no occlusions; (c) a center hub of the RS and portions of the blades close to the center hub have a substantially homogeneous color, a substantially smooth profile, and a substantially continuous geometry; and (d) the blades of the RS are one of the largest moving objects or the only moving objects in the image processing region.
